(19) United States
(12) Patent Application Publication
(10) Pub. No.: US 2026/0137072 A1
(43) Pub. Date: May 21, 2026

(54) METHOD AND APPARATUS FOR DAMAGING WEEDS FROM A GROOMED LAWN AREA

(71) Applicant: Venture Products, Inc., Orrville, OH (US)

(72) Inventors: Ryan STEINER, Dalton, OH (US); Michael S. HOFFMAN, Orrville, OH (US); Andrew POLASKO, Copley, OH (US); Chad R. BADGER, Fredericksburg, OH (US)

(73) Assignee: Venture Products, Inc., Orrville, OH (US)

(21) Appl. No.: 19/178,339

(22) Filed: Apr. 14, 2025

Related U.S. Application Data
(60) Provisional application No. 63/633,910, filed on Apr. 15, 2024.

(51) Int. Cl. A01M 21/02

(52) U.S. Cl. CPC A01M 21/02

(57) ABSTRACT

An implement for attachment with a vehicle for destroying unwanted vegetation rooted in a lawn area. The implement may include a frame, a housing that operably engages with the frame, a brush that rotatably engages with the housing, and an auger that rotatably engages with the housing. The auger may include a drive shaft a plurality of blades that removably engages with the drive shaft.

### REFERENCE TO RELATED APPLICATIONS

This application claims the benefit of U.S. Provisional Application Ser. No. 63/633,910, filed on Apr. 15, 2024; the disclosure of which is incorporated herein by reference.

### TECHNICAL FIELD

This disclosure is directed to an implement for damaging and/or destroying weeds and other unwanted vegetation from a lawn or ground area to stunt growth of weeds and other unwanted vegetation.

### BACKGROUND ART

Turf grass is commonly found on vast amounts of acres covering the United States, including lawns, parks, commercial landscapes, sports fields, and golf courses. Turf grass is also commonly used in various areas that may experience frequent mowing and intense traffic while still providing a uniform surface and appearance for various activities, including sports. However, entities that own turf grass areas or facilities, such as sports fields, are criticized for using significant quantities of water, fertilizer, and pesticides to maintain the look and health of the turf grass. While such material is suitable for maintaining turf grass, extensive uses of pesticides on various areas of turf grass increase concerns over potential health risks for individual that continually play or use these turf grass for sport or leisure activities.

To prevent the overuse of pesticides on various areas of turf grass, other non-chemical are used but have disadvantages and/or detrimental effects. In one instance, owners of such lands or properties may manually pull and/or remove said weeds from the turf grass; however, this particular process is time consuming and requires extensive labor depending on the size of the area and the amount of weeds provided in that area. In another instance, owners of such lands or properties may routinely adjust the mowing heights to prevent such growth of unwanted weeds; however, such adjustment of mowing heights may still not rid unwanted weeds from these specific lands and properties due to specie of the weed. In yet another example, other turf and lawncare machines have been used in this space to physically remove such weeds; however, these machines may require extensive repair and maintenance with respect to particular features and/or components provided with these machines in removing weeds from given lands and properties.

### SUMMARY OF THE INVENTION

In one aspect, an exemplary embodiment of the present disclosure may provide an implement for attachment with a vehicle. The implement includes a frame, a housing operably engaged with the frame, a brush rotatably engaged with the housing, and an auger rotatably engaged with the housing. The auger includes a drive shaft and a plurality of blades removably engaged with the drive shaft.

This exemplary embodiment or another exemplary embodiment may further include that each blade of the plurality of blades is individually removably engaged with the drive shaft. This exemplary embodiment or another exemplary embodiment may further include a first drive axis defined along the brush; and a second drive axis defined along the auger; wherein the second drive axis of the auger is positioned behind the first drive axis of the brush. This exemplary embodiment or another exemplary embodiment may further include that the auger further comprises: a first set of teeth of a first set of blades of the plurality of blades; and a second set of teeth of a second set of blades of the plurality of blades; wherein the first set of teeth and the second set of teeth are offset from one another are configured to capture one or more types of vegetation provided on a ground surface. This exemplary embodiment or another exemplary embodiment may further include that the auger further comprises: a set of spacers operably engaged with the drive shaft and the plurality of blades; wherein each spacer of the set of spacers separates two adjacent blades of the plurality of the blades along the drive shaft. This exemplary embodiment or another exemplary embodiment may further include that each blade of the plurality of blades further comprises: a leading edge extending into a peripheral wall of the blade; and a trailing edge extending from the leading edge to the peripheral wall. This exemplary embodiment or another exemplary embodiment may further include that the auger further comprises: a keyway defined between a first end of the drive shaft and a second end of the drive shaft; and a keyed portion provided with each blade of the plurality of blades that is operable to be received by the keyway of the drive shaft. This exemplary embodiment or another exemplary embodiment may further include that that auger further comprises: a D-shaped outer surface defined between a first end of the drive shaft and a second end of the drive shaft; and a D-shaped inner surface defined by each blade of the plurality of blades that is operable to receive the D-shaped outer surface of the drive shaft. This exemplary embodiment or another exemplary embodiment may further include that each blade of the first set of blades comprises: a peripheral wall extending between a first side of the blade and a second side of the blade; a central axis extending between the first side and the second side; and a first radius measured between the central axis and the peripheral wall; wherein the first radius is greater than a radius of the drive shaft. This exemplary embodiment or another exemplary embodiment may further include that each blade of the second set of blades comprises: a peripheral wall extending between a first side of the blade and a second side of the blade; a central axis extending between the first side and the second side; and a second radius measured between the central axis and the peripheral wall; wherein the second radius is greater than the first radius. This exemplary embodiment or another exemplary embodiment may further include a first distance measured between two teeth of the first set of teeth of the first set of blades; and a second distance measured between two teeth of the second set of teeth of the second set of blades; wherein the second distance is greater than the first distance. This exemplary embodiment or another exemplary embodiment may further include that the plurality of blades further comprises:
a third set of teeth of a third set of blades of the plurality of blades; wherein the third set of teeth is offset from the first set of teeth and the second set of teeth are offset. This exemplary embodiment or another exemplary embodiment may further include that the auger further comprises a third set of blades, each blade of the third set of blades comprises: a peripheral wall extending between a first side of the blade and a second side of the blade; a central axis extending between the first side and the second side; and
a third radius measured between the central axis and the peripheral wall; wherein the third radius is greater than the first radius and the second radius. This exemplary embodiment or another exemplary embodiment may further include a third distance measured between two teeth of a third set of teeth of a third set of blades; wherein the third distance is greater than the second distance and the first distance. This exemplary embodiment or another exemplary embodiment may further include a set of support brackets operably engaged with the housing and the drive shaft of the auger between a first end of the drive shaft and a second end of the drive shaft; wherein the set of support brackets is positioned behind the brush.

This exemplary embodiment or another exemplary embodiment may further include that the drive system is configured to match velocities of lateral surfaces of the auger and the brush. This exemplary embodiment or another exemplary embodiment may further include that the drive system comprises: a power take-off (PTO) system adapted to be operable with the vehicle; a brush drive system rotatably engaged with the PTO system; and an auger drive system rotatably engaged with the PTO system and is separate from the brush drive system, wherein the auger drive shaft is a part of the auger drive system. This exemplary embodiment or another exemplary embodiment may further include that the drive system further comprises: a gearbox of the PTO system; an auger drive axle of the auger belt system that rotatably engages with the gearbox at a first output; and a brush drive axle of the auger belt system that rotates engages with the gearbox at a second output opposite to the first output. This exemplary embodiment or another exemplary embodiment may further include a first side of the housing supporting the auger drive system; and a second side of the housing opposite to the housing supporting the brush drive system; and a cavity defined between the first side and the second side housing the brush and the auger. This exemplary embodiment or another exemplary embodiment may further include that the auger further comprises: a first set of blades of the plurality of blades; a second set of blades of the plurality of blades; and a third set of blades of the plurality of blades; wherein the first set of blades, the second set of blades, and the third set of blades are offset from one another and are configured to capture one or more types of vegetation provided on a ground surface. This exemplary embodiment or another exemplary embodiment may further include that the auger further comprises: a first radius defined by each blade of the first set of blades; a second radius defined by each blade of the second set of blades that is greater than the first radius; and a third radius defined by each blade of the third set of blades that is greater than the first radius and the second radius. This exemplary embodiment or another exemplary embodiment may further include that the first set of blades, the second set of blades, and the third set of blades are arranged in a stairstep configuration. This exemplary embodiment or another exemplary embodiment may further include that each spacer of the set of spacers in integrally formed with a respective blade of the plurality of blades. This exemplary embodiment or another exemplary embodiment may further include that the keyway is D-shaped along an outer surface of the drive shaft defined between the first end of the drive shaft and the second end of the drive shaft; and wherein the keyed portion provided with each blade of the plurality of blades is D-shaped and is operable to receive the D-shaped keyway of the drive shaft.

In another aspect, an exemplary embodiment of the present disclosure may provide a method of damaging unwanted vegetation rooted in a lawn area, the method comprising: engaging a plurality of blades of an auger of an implement with a drive shaft of the auger; engaging the implement with a vehicle; rotating the auger and a brush of the implement simultaneously; capturing the unwanted vegetation at a first height by at least one tooth of a set of teeth of a blade of the plurality of blades; lifting the unwanted vegetation, by the blade of the plurality blades, into the brush; and damaging the unwanted vegetation rooted in the lawn area.

This exemplary embodiment or another exemplary embodiment may further include that the step of engaging the plurality of blades with the drive shaft further includes that each blade of the plurality of blades is individually engaged with the drive shaft. This exemplary embodiment or another exemplary embodiment may further include that the step of rotating the auger and the brush of the implement simultaneously further comprising: rotating the brush about a first drive axis; and rotating the auger about a second drive axis; wherein the second drive axis is positioned behind the first drive axis. This exemplary embodiment or another exemplary embodiment may further include capturing the unwanted vegetation at a second height by at least one tooth of a second set of teeth of a second blade of the plurality of blades, wherein the second height is greater than the first height; and lifting the unwanted vegetation, by the second blade of the plurality blades, into the brush. This exemplary embodiment or another exemplary embodiment may further include steps of capturing the unwanted vegetation at a third height by at least one tooth of a third set of teeth of a third blade of the plurality of blades, wherein the third height is greater than the first height and the second height; and lifting the unwanted vegetation, by the third blade of the plurality blades, into the brush. This exemplary embodiment or another exemplary embodiment may further include that the step of engaging the plurality of blades with the drive shaft further comprises: inserting a keyed portion of each blade of the plurality of blades into a keyway defined inside of the drive shaft. This exemplary embodiment or another exemplary embodiment may further include that the step of engaging the plurality of blades with the auger drive shaft further includes that each blade of the plurality of blades is removably engaged with the auger drive shaft.

In another aspect, another exemplary embodiment of the present disclosure may provide an implement for attachment with a vehicle. The implement includes a frame, a housing operably engaged with the frame, a brush rotatably engaged with the housing; an auger rotatably engaged with the housing and parallel with the brush; and a drive system operably engaged with the brush and the auger and configured to simultaneously rotate the brush and the auger.

This exemplary embodiment or another exemplary embodiment may further include that the drive system is configured to rotate the brush at a first rotational speed and the auger at a second rotational speed that is different than the first rotational speed. This exemplary embodiment or another exemplary embodiment may further include that the second rotational speed of the auger is three times greater than the first rotational speed of the brush. This exemplary embodiment or another exemplary embodiment may further include that the first rotational speed generated on the brush by the drive system is approximately 1,600 revolutions per minute; and wherein the second rotational speed generated on the auger by the drive system is approximately 4,800 revolutions per minute. This exemplary embodiment or another exemplary embodiment may further include a first drive axis defined along the brush; and a second drive axis defined along the auger; wherein the second drive axis of the auger is positioned behind the first drive axis of the brush. This exemplary embodiment or another exemplary embodiment may further include that the drive system comprises: a power take-off (PTO) system adapted to be operable with a vehicle; a brush drive system rotatably engaged with a PTO drive shaft of the PTO system; and an auger drive system rotatably engaged with a PTO drive shaft of the PTO system and is separate from the brush drive system. This exemplary embodiment or another exemplary embodiment may further include that the drive system comprises: a PTO brush pulley of the brush drive system operably engaged with the PTO drive shaft and defining a first diameter; and a PTO auger pulley of the auger drive system operably engaged with the PTO drive shaft and defining a second diameter that is less than the first diameter. This exemplary embodiment or another exemplary embodiment may further include that the brush drive system comprises: a first jockey pulley positioned downstream of the PTO brush pulley; a second jockey pulley positioned downstream of the first jockey pulley; and a brush pulley positioned downstream of the second jockey pulley and is secured to the brush. This exemplary embodiment or another exemplary embodiment may further include that the brush drive system further comprises: a tensioner operably engaged with the housing and configured to provide a predetermined tension along a brush belt of the brush drive system; wherein the tensioner is positioned downstream of the brush pulley. This exemplary embodiment or another exemplary embodiment may further include that the tensioner of the brush drive system comprises: a first tension pulley operably engaged with a tension arm of the tensioner and is positioned downstream of the brush pulley; and a third jockey pulley operably engaged with the tension arm of the tensioner and is positioned downstream of the first tension pulley. This exemplary embodiment or another exemplary embodiment may further include that the auger drive system comprises: a first jockey pulley positioned downstream of the PTO auger pulley; a second jockey pulley positioned downstream of the first jockey pulley; and an auger pulley downstream of the second jockey pulley and is secured to the auger. This exemplary embodiment or another exemplary embodiment may further include that the auger drive system further comprises: a tensioner operably engaged with the housing and configured to provide a predetermined tension along an auger belt of the auger drive system; wherein the tensioner is positioned downstream of the brush pulley. This exemplary embodiment or another exemplary embodiment may further include that the tensioner of the auger drive system comprises: a tension pulley operably engaged with a tension arm of the tensioner and is positioned is positioned downstream of the brush pulley.

In another aspect, another exemplary embodiment of the present disclosure may provide a method of damaging unwanted vegetation rooted in a lawn area. The method includes steps of: engaging an implement to a vehicle; generating a rotational force by the vehicle; transferring the rotational force from the vehicle to a drive system of the implement; rotating a brush of the implement about a first drive axis by the drive system; rotating an auger of the implement about a second drive axis by the drive system, wherein the second rotational axis is positioned behind the first drive axis; lifting the unwanted vegetation, by the auger, into the brush; and damaging the unwanted vegetation rooted in the lawn area.

This exemplary embodiment or another exemplary embodiment may further include that the step of rotating the brush about the first drive axis further includes: rotating the brush at a first rotational speed; and wherein the step of rotating the auger about the second drive axis further includes: rotating the auger at a second rotational speed that is different than the first rotational speed. This exemplary embodiment or another exemplary embodiment may further include that the second rotational speed of the auger is three times greater than the first rotational speed of the brush. This exemplary embodiment or another exemplary embodiment may further include that the first rotational speed generated on the brush by the drive system is approximately 1,600 revolutions per minute; and wherein the second rotational speed generated on the auger by the drive system is approximately 4,800 revolutions per minute. This exemplary embodiment or another exemplary embodiment may further include that the step of transferring the rotational force from the vehicle to the drive system further comprises: transferring the rotational force from the vehicle to a power take-off (PTO) system of the implement; transferring the rotational force from the PTO system to a brush drive system of the implement; and transferring the rotational force from the PTO system to an auger drive system of the implement. This exemplary embodiment or another exemplary embodiment may further include that the steps of rotating the brush and rotating the auger further comprises: rotating the brush in a first rotational direction about the first drive axis; and rotating the auger in a second rotational direction about the second drive axis; wherein the first rotational direction and the second rotational direction are directed at one another. This exemplary embodiment or another exemplary embodiment may further include that the brush drive system and the auger drive system are each belt driven systems.

In another aspect, another exemplary embodiment of the present disclosure may provide an implement for attachment with a vehicle. The implement includes a frame, a housing operably engaged with the frame, a brush rotatably engaged with the frame, and an auger rotatably engaged with the frame and parallel with the brush. The brush includes a drive shaft, a plurality of bristles operably engaged with the drive shaft, and a flywheel operably engaged with the drive shaft.

This exemplary embodiment or another exemplary embodiment may further include that the flywheel provides continuous power curve to the brush as the brush rotates. This exemplary embodiment or another exemplary embodiment may further include that the flywheel comprises: an inner hub that is removably engageable with the drive shaft of the brush. This exemplary embodiment or another exemplary embodiment may further include that the inner hub comprises: a first end; a second end opposite to the first end; and a passageway defined between the first end and the second end and is configured to receive a portion of the drive shaft of the brush. This exemplary embodiment or another exemplary embodiment may further include that the inner hub further comprises: a first keyway defined in an inner wall of the inner hub away from the passageway; and wherein the drive shaft of the brush comprises: a second keyway defined along a portion of the drive shaft. This exemplary embodiment or another exemplary embodiment may further include that the brush further comprises: a key receivable by the first keyway of the flywheel and the second keyway of the drive shaft for securing the flywheel and the drive shaft with one another. This exemplary embodiment or another exemplary embodiment may further include that the flywheel further comprises: an outer hub extending outwardly from the inner hub and is configured to provide a counterbalance for the brush. This exemplary embodiment or another exemplary embodiment may further include that the housing comprises: a top wall; a pair of side walls extending downwardly from the top wall; and a rear wall extending downward from the top wall and positioned between the pair of side walls; wherein the flywheel is positioned proximate to a side wall of the pair of side walls. This exemplary embodiment or another exemplary embodiment may further include that the housing further comprises: a cavity collectively defined by the top wall, the pair of side walls, and the rear wall; wherein the brush and the auger are substantially positioned inside of the cavity; and wherein the flywheel is positioned outside of the cavity.

In another aspect, another exemplary embodiment of the present disclosure may provide a method of damaging unwanted vegetation rooted in a lawn area. The method includes steps of: engaging a flywheel of an implement with a drive shaft of a brush of the implement; engaging the implement with a vehicle; rotating an auger of the implement and the brush simultaneously through a first thickness of the lawn area; wherein the brush is rotated at a first rotational speed; capturing the unwanted vegetation by the auger; lifting the unwanted vegetation, by the auger, into the brush; and damaging the unwanted vegetation rooted in the lawn area.

This exemplary embodiment or another exemplary embodiment may further include steps of rotating the auger of the implement and the brush simultaneously through a second thickness of the lawn area that is greater than first thickness of the lawn area; and maintaining the first rotational speed of the brush by the flywheel. This exemplary embodiment or another exemplary embodiment may further include that the step of maintaining the first rotational speed of the brush by the flywheel further includes that the brush is maintained at approximately 1,600 revolutions per minute when rotating through the second thickness of the lawn area. This exemplary embodiment or another exemplary embodiment may further include that the step of engaging the flywheel with the drive shaft of the brush further comprises: engaging a portion of the drive shaft inside of an inner hub of the flywheel; and locking the inner hub and the drive shaft with a key. This exemplary embodiment or another exemplary embodiment may further include steps of inserting the key through a first keyway defined in the inner hub of the flywheel; and inserting the key through a second keyway defined in the drive shaft. This exemplary embodiment or another exemplary embodiment may further include steps of positioning the brush and the auger inside of a cavity defined by a housing of the implement; and positioning the flywheel outside of the cavity defined by the housing.

In another aspect, another exemplary embodiment of the present disclosure may provide a method of damaging unwanted vegetation rooted in a lawn area. The method includes steps of: engaging a flywheel of an implement with a drive shaft of a brush of the implement; engaging the implement with a vehicle; rotating the brush simultaneously through a first thickness of the lawn area about a first rotational axis; wherein the brush is rotated at a first rotational speed; rotating an auger of the implement about a second rotational axis behind the first rotational axis; capturing the unwanted vegetation by the auger; lifting the unwanted vegetation, by the auger, into the brush; and damaging the unwanted vegetation rooted in the lawn area.

This exemplary embodiment or another exemplary embodiment may further include steps of rotating the auger of the implement and the brush simultaneously through a second thickness of the lawn area that is greater than first thickness of the lawn area; and maintaining the first rotational speed of the brush by the flywheel. This exemplary embodiment or another exemplary embodiment may further include that the step of maintaining the first rotational speed of the brush by the flywheel further includes that the brush is maintained at approximately 1,600 revolutions per minute when rotating through the second thickness of the lawn area. This exemplary embodiment or another exemplary embodiment may further include that the step of engaging the flywheel with the drive shaft of the brush further comprises: engaging a portion of the drive shaft inside of an inner hub of the flywheel; and locking the inner hub and the drive shaft with a key. This exemplary embodiment or another exemplary embodiment may further include steps of inserting the key through a first keyway defined in the inner hub of the flywheel; and inserting the key through a second keyway defined in the drive shaft. This exemplary embodiment or another exemplary embodiment may further include steps of positioning the brush and the auger inside of a cavity defined by a housing of the implement; and positioning the flywheel outside of the cavity defined by the housing.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a first side elevation view of an implement in accordance with an aspect of the present disclosure, wherein the implement illustrated in operatively engaged with a tractor.

FIG. 2 is a partial top, rear, first side isometric perspective view of the implement shown in FIG. 1.

FIG. 3 is a partial top, front, first side isometric perspective view of the implement shown in FIG. 1, wherein a brush having a flywheel of the implement are shown.

FIG. 4 is a partial top, front, second side isometric perspective view of the implement shown in FIG. 1, wherein a brush drive system and an auger drive system of the implement are shown.

FIG. 4A is a partial top, front, second side isometric perspective view of the implement shown in FIG. 1, wherein the auger drive system of the implement is shown.

FIG. 4B is a partial top, front, second side isometric perspective view of the implement shown in FIG. 1, wherein a tensioner of the auger drive system of the implement is shown.

FIG. 4C is a partial top, front, second side isometric perspective view of the implement shown in FIG. 1, wherein the brush drive system of the implement is shown.

FIG. 4D is a partial top, front, second side isometric perspective view of the implement shown in FIG. 1, wherein a tensioner of the brush drive system of the implement is shown.

FIG. 5A is a partial bottom plan view of the implement, wherein first portions of a brush and an auger of the implement are shown at the second side of the implement.

FIG. 5B is a partial bottom plan view of the implement, wherein second portions of the brush and the auger of the implement are shown at the first side of the implement.

FIG. 6 is a partial cross-sectional view of the implement.

FIG. 7 is a partial top, front, second side isometric perspective view of a body of the implement and the auger of the implement.

FIG. 8 is a partial front elevation view of the auger of the implement.

FIG. 9 is an exploded view of the auger, wherein the auger includes a sets of blades, a set of spacers, and a drive shaft.

FIG. 10 is a side elevation view of a first blade of the sets of blades.

FIG. 10A is an enlargement of the highlighted region shown in FIG. 10.

FIG. 11 is a side elevation view of a second blade of the sets of blades.

FIG. 12 is a side elevation view of a third blade of the sets of blades.

FIG. 13 is a side elevation view of the first blade (shown in FIG. 10), the second blade (shown in FIG. 11), and the third blade (shown in FIG. 12) aligned with one another.

FIG. 14 is an exploded view of an auger in accordance with another aspect of the present disclosure, wherein the auger includes sets of blades, a set of spacers, and a drive shaft.

FIG. 15A is an operational view of the implement traversing over a ground surface having at least one unwanted vegetation.

FIG. 15B is another operational view similar to FIG. 15A, but at least one blade of the auger captures at least one weed of the unwanted vegetation.

FIG. 15C is another operational view similar to FIG. 15B, but the at least one blade of the auger pushes the at least one weed into the brush to damage and/or destroy the at least one weed.

FIG. 15D is another operational view similar to FIG. 15C, but the at least one blade of the auger continues to move the at least one weed into the brush for damaging and/or destroying the unwanted vegetation from the ground surface.

FIG. 15E is another operational view continuing from FIG. 15D showing the unwanted vegetation damaged.

FIG. 16 is a flowchart depicting a method of destroying the unwanted vegetation from a lawn area.

FIG. 17 is another flowchart depicting a method of destroying the unwanted vegetation from a lawn area.

FIG. 18 is another flowchart depicting a method of destroying the unwanted vegetation from a lawn area.

FIG. 19 is another flowchart depicting a method of destroying the unwanted vegetation from a lawn area.

FIG. 20 is a first side elevation view of an implement in accordance with a second aspect of the present disclosure, wherein the implement illustrated in operatively engaged with the tractor.

FIG. 21 is a top plan view of the implement shown in FIG. 20, wherein a power takeoff (PTO) drive system, a brush drive system, and an auger drive system of the implement are shown in phantom lines.

FIG. 21A is a top plan view of the implement shown in FIG. 20, wherein PTO drive system, brush drive system, and auger drive system of the implement are shown in isolation.

FIG. 22 is a partial top, front, second side isometric perspective view of the implement shown in FIG. 20, wherein the brush drive system of the implement is shown.

FIG. 23 is a partial top, front, first side isometric perspective view of the implement shown in FIG. 20, wherein the auger drive system of the implement is shown.

FIG. 24 is a partial front elevation view of the auger of the implement.

FIG. 25 is an exploded view of the auger, wherein the auger includes a sets of blades, a set of spacers integrated into the set of blades, and a drive shaft.

FIG. 26 is a first side elevation view of a blade of a second set of blades of the sets of blades.

FIG. 27 is a sectional view of the blade of the second set of blades of the sets of blades shown in FIG. 26.

Similar numbers refer to similar parts throughout the drawings.

### DETAILED DESCRIPTION

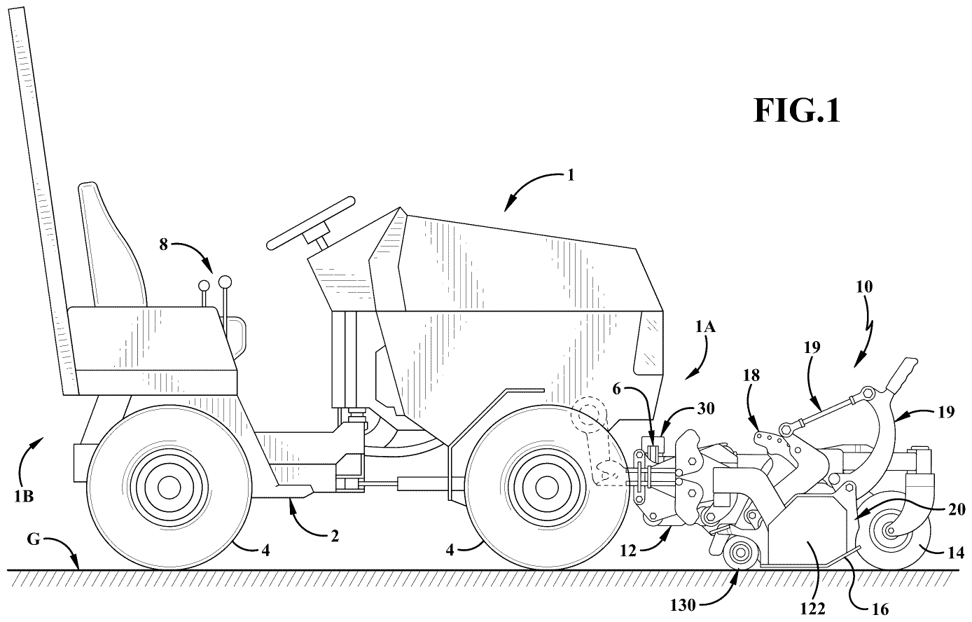

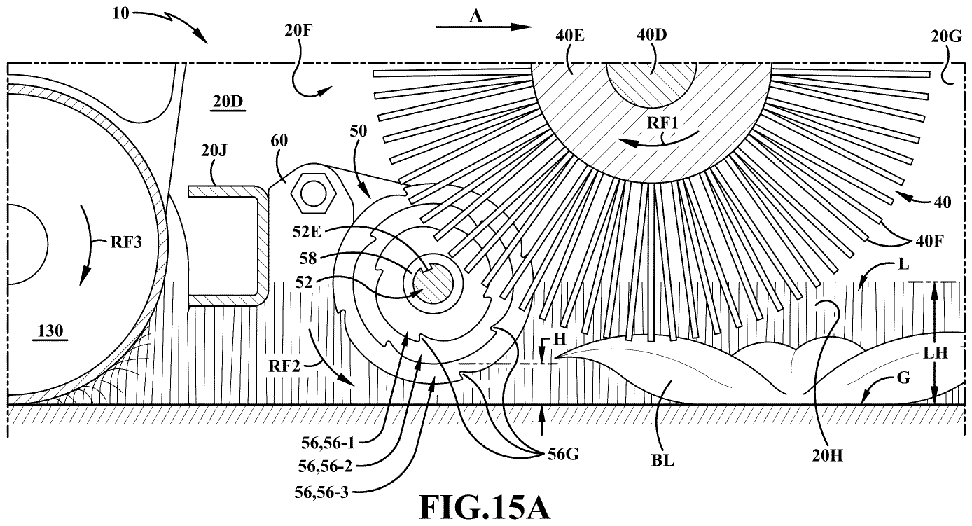

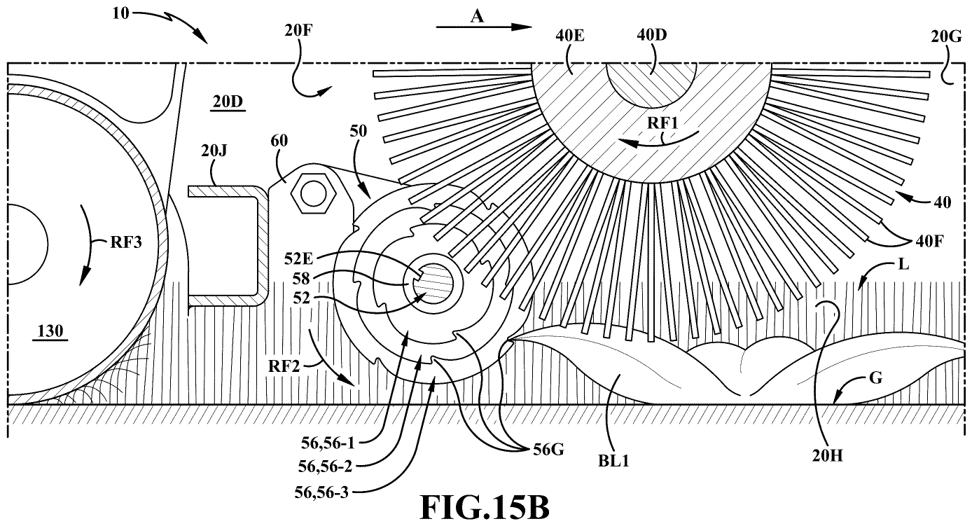

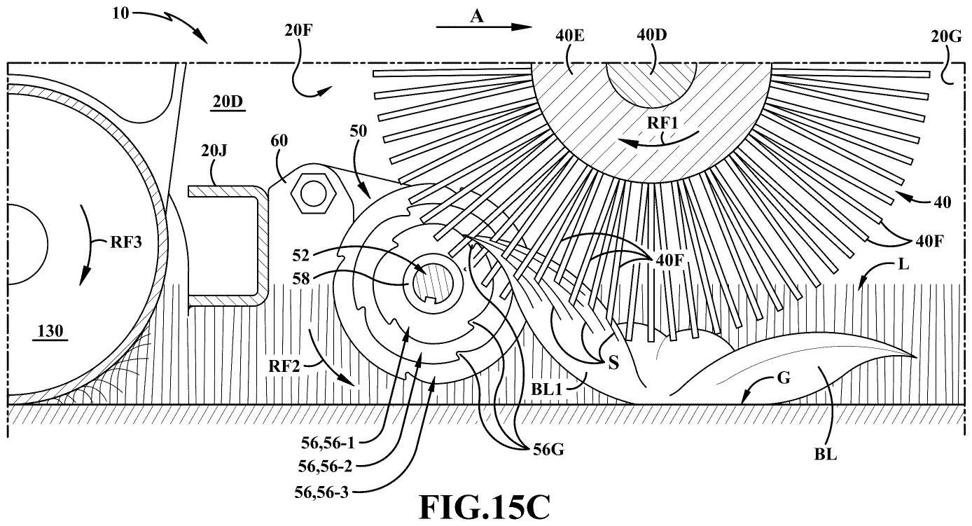

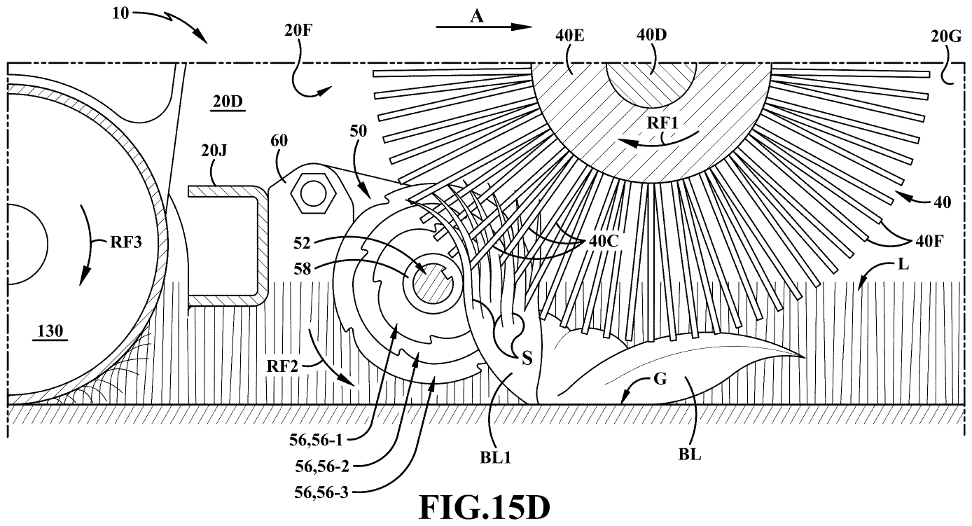

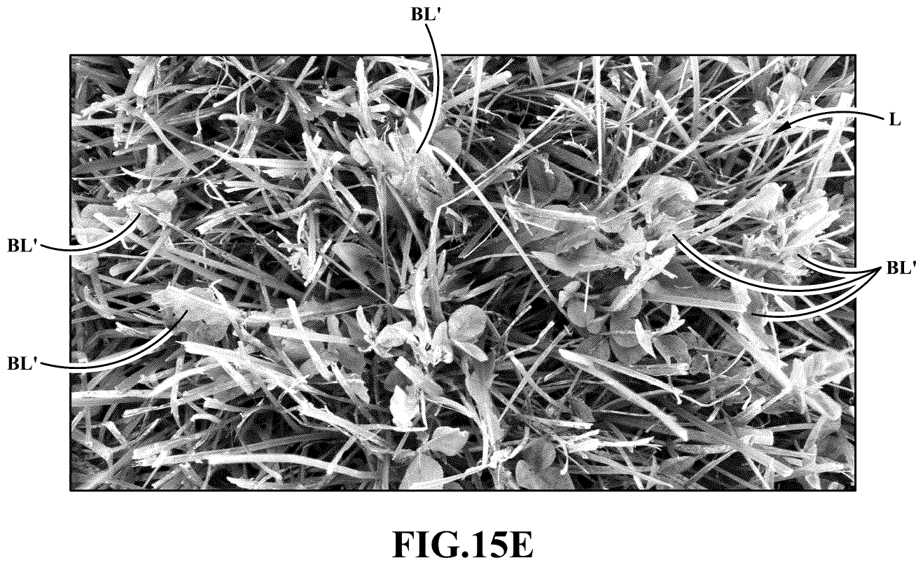

A drivable outdoor power equipment device in accordance with the present disclosure is illustrated in FIG. 1 and is shown generally at 1; the drivable outdoor power equipment device 1 may also be referred to as a tractor or vehicle herein. The drivable outdoor power equipment device 1 may also be referred to as a tractor or vehicle herein. Vehicle 1 has a front end 1A, a rear end 1B longitudinally opposite to the front end 1A, and a longitudinal direction defined therebetween. During operation, vehicle 1 will typically travel in a forward direction indicated by the arrow “A” (FIGS. 15A-15D). When vehicle 1 moves in the forward direction “A”, the front end 1A comprises the leading end of vehicle 1. In some instances, vehicle 1 may need to reverse, in which case the direction of travel will be opposite to the direction indicated by arrow “A”, and then rear end 1B will comprise the leading end of the vehicle 1.

Vehicle 1 includes an articulating frame 2 upon which grounding engaging wheels 4 are mounted so that vehicle 1 may be driven across a ground surface. The tractor may include a power takeoff (PTO) system 6 that may connect with a compatible implement described herein or that is commercially available. During operation, the PTO system 6 may deliver and/or transfer mechanical or rotational energy to an implement connected to the PTO system 6. Such transferring of mechanical energy from the PTO system 6 to the connected implement may be controlled by a control system 8 provided on the vehicle 1 and accessible by an operator of vehicle 1.

It will be understood that any suitable vehicle, tractor, or drivable outdoor power equipment device may be used with an implement discussed herein. One exemplary vehicle 1 for use with an implement discussed herein is a Ventrac compact tractor commercially available for sale and known in the industry as a Ventrac 4520 tractor.

Referring to FIG. 1, an implement 10 is equipped to the vehicle 1 using an attachment frame assembly 12. With reference to FIG. 1, implement 10 may be any implement 10 suitable for connection to a tractor, and although depicted and described herein as a front-driven implement, implement 10 may likewise be attached to a vehicle 1 in any suitable position according to the desired implementation. For simplicity and clarity in the disclosure, implement 10 will be described generally as a broadleaf weed or unwanted vegetation control machine; however, the attachment frame assembly 12 may be utilized with any suitable implement as will become apparent herein. In one exemplary embodiment, attachment frame assembly 12 may be attachment frame assembly disclosed in U.S. Pat. No. 12,178,154 with an issue date of Dec. 31, 2024.

Implement 10 may include at least one ground-engaging member, which may be a wheel, a skid, a ski, or other suitable ground-engaging devices. Such ground-engaging surfaces are depicted and referenced herein as wheels 14 that are fixed with the implement 10. Collectively, these ground-engaging members may define the operational height of implement 10 as discussed further herein. Where implement 10 is a broadleaf weed control machine, wheels 14 may be adjusted by adjustment mechanisms (which are discussed below) to set the height of the machine, such as the height at which vegetation will be captured and damaged in the lawn or turf area by a brush assembly and an auger assembly of the broadleaf weed control machine; such components and elements of the brush assembly and auger assembly of the broadleaf weed control machine are discussed in greater detail below. Implement 10 also include skids 16 that are fixed and spaced apart from the wheels 14. In operation, skids 16 are configured to sit below a brush and/or auger of the implement 10 so that such brush and auger are free from driving into and/or scalping the lawn or turf; such description of the brush and auger of implement 10 are described in greater detail below. When implement 10 is not being used or operated, the skids 16 may provide support to the implement 10.

Implement 10 may further include one or more frame components generally indicated at 18 and may further include one or more adjustment mechanisms indicated generally at 19. It will be understood that these components, namely, frame components 18 and/or adjustment mechanisms 19, may vary depending on the type, size, and/or desired operation of implement 10 and may be configured or constructed according to known configurations and/or operation as dictated by the desired implementation and the particulars of any specific implement 10 employed with attachment frame assembly 12. It will be further understood that the adjustment mechanisms 19 may include one or more different types of adjustment mechanisms 19 that may allow for any suitable adjustments to implement as desired. According to one non-limiting example, adjustment mechanisms 19 may include operational height adjustment mechanisms as well as any suitable or desired adjustment system to raise or lower implement 10 from a stowed position to a deployed position and vice versa. Adjustment mechanisms 19 are therefore contemplated to include any suitable frame members, attachment mechanisms or fasteners, support members or structures, as well as any necessary and/or suitable adjustment means such as hydraulic cylinders, pneumatic actuators or the like. For purposes of clarity and simplicity in this disclosure, adjustment mechanisms 19 are understood to be included and operate according to known principles and will be omitted from further discussion herein unless specifically stated otherwise. Further, some structures and components described below may include mounting or attachment points for adjustment mechanisms 19 as needed, and will be omitted from discussion for clarity. It will be understood that these mounting and/or attachment points may be modified as necessary.

Frame components 18 of implement 10 may connect or otherwise secure implement 10 to the attachment frame assembly 12, which will be discussed in further detail below. Generally, frame components 18 may include any necessary or desired elements to support implement 10 and its various elements, and may vary in size, type, configuration, placement, and connection as dictated by the type of implement 10 used and the operational and structural needs thereof. Accordingly, as discussed herein, frame components 18 of implement 10 are discussed generally and attachment of other components thereto and removal therefrom may be accomplished by any suitable means, unless specifically stated otherwise.

It should also be noted that frame components 18 and adjustment mechanisms 19 of implement 10 may also include indicia or markings (not illustrated) that display operational heights of the implement 10. Such indicia or markings will assist the operator or user of the implement 10 to quickly adjust the operational height of the implement 10 in order to adequately damage and/or destroy weeds and unwanted vegetation from a lawn or turf area; such acts of damaging and/or destruction of weeds and unwanted vegetation from a lawn or turf area are discussed in greater detail below. The operational height of the implement 10 is also based on the lawn height and/or height at which the weeds or unwanted vegetation are positioned at relative to a bottom end of a housing of the implement 10 and/or the ground surface.

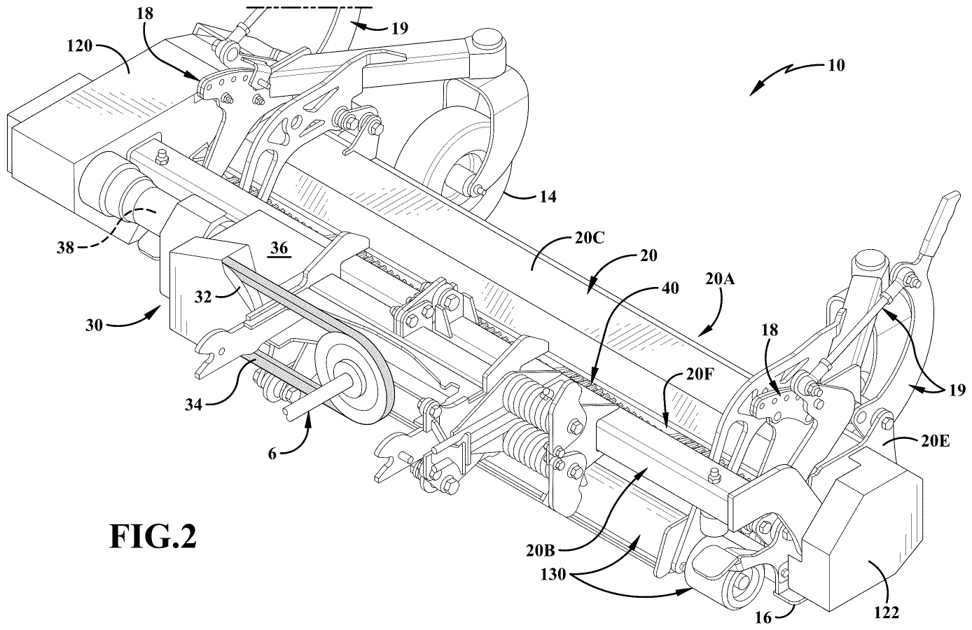

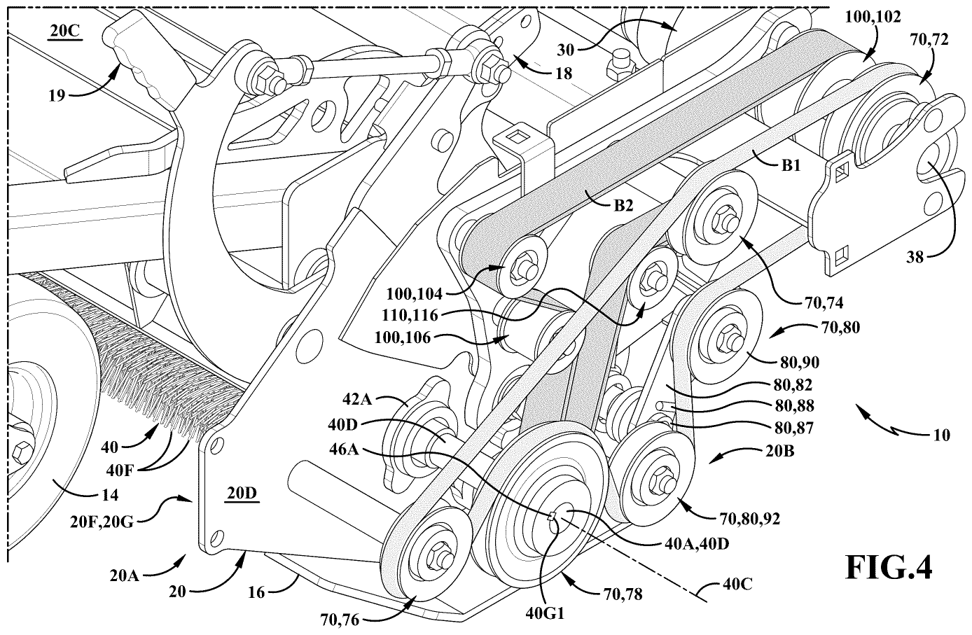

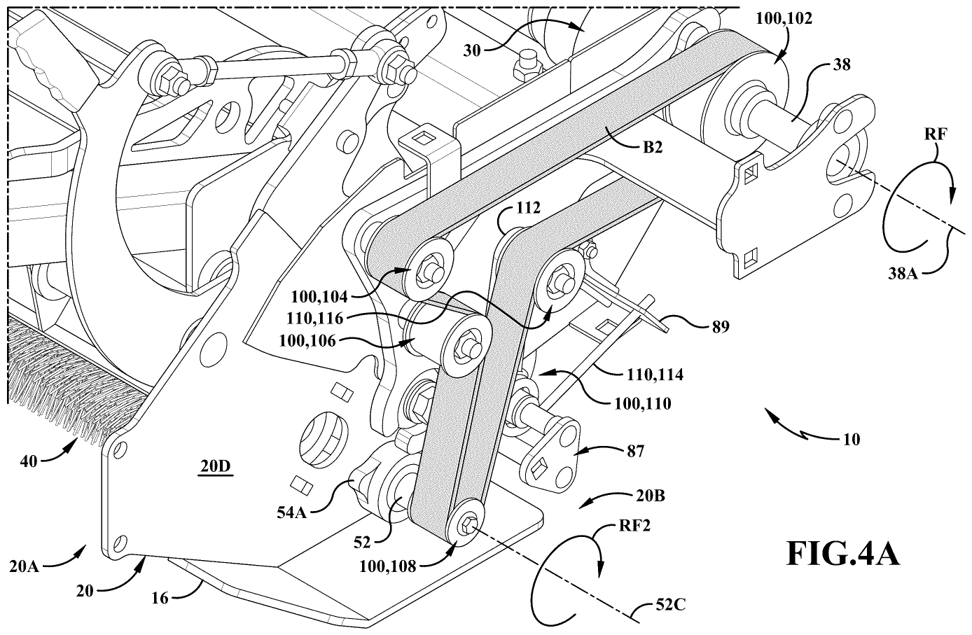

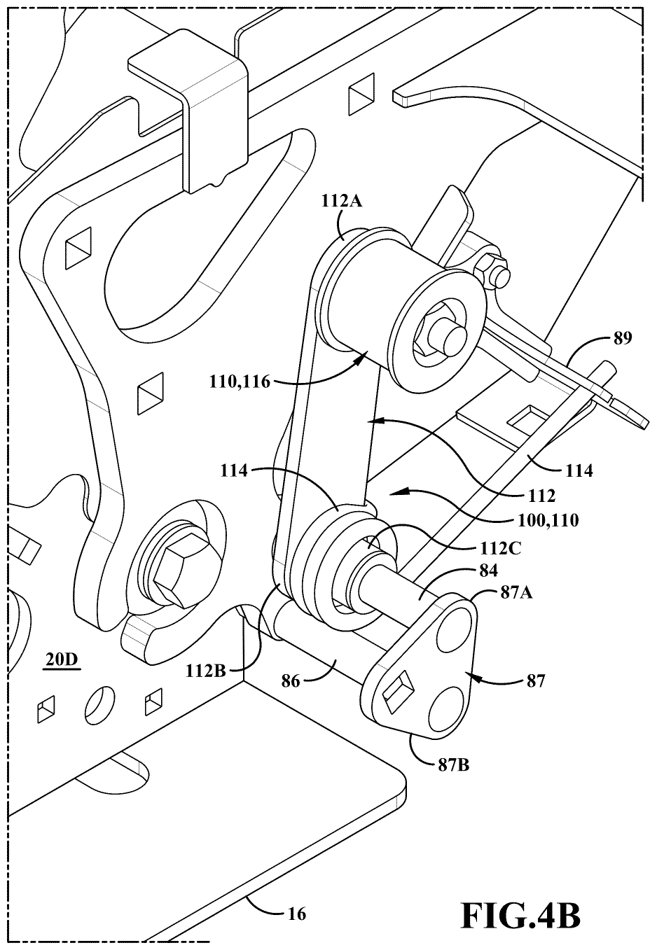

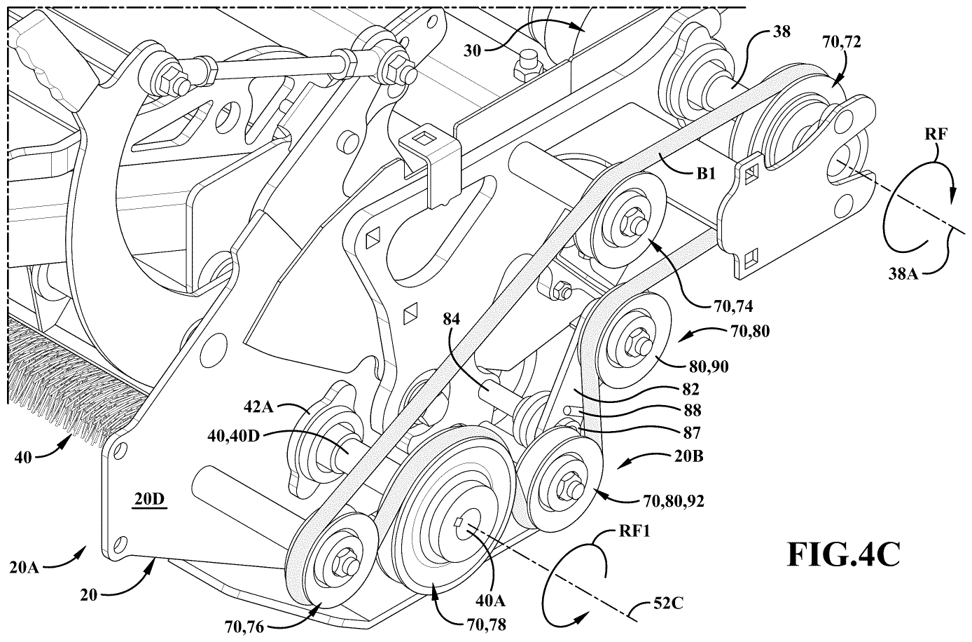

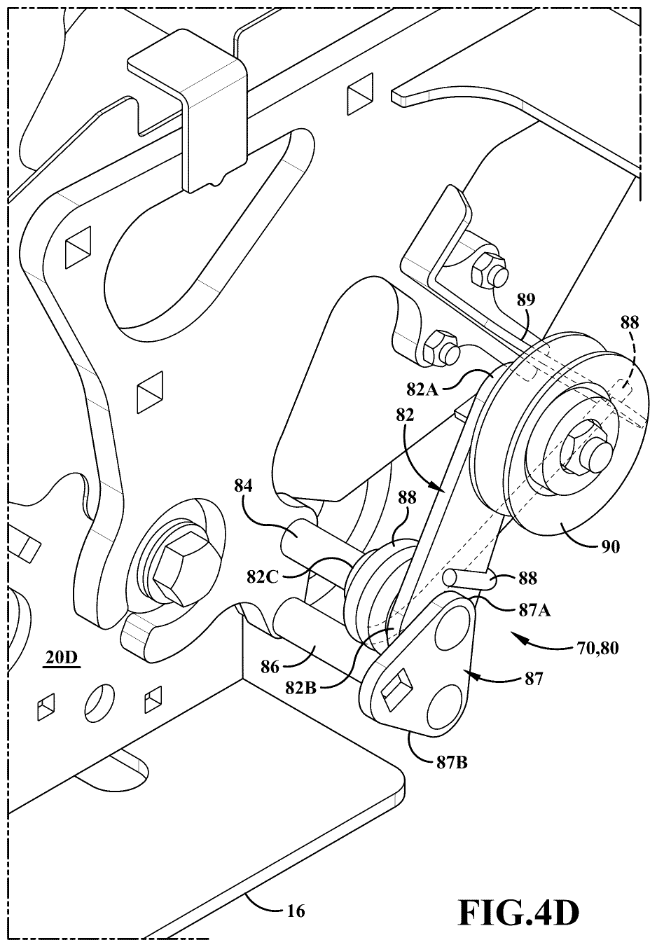

Implement 10 may further include a housing 20 which may house one or more operational components of the implement 10. As best seen in FIG. 2, the housing 20 includes a front end 20A, a rear end 20B opposite to the front end 20A, a top wall 20C positioned between the front end 20A and the rear end 20B, and a pair of side walls 20D, 20E that extends downwardly from top wall 20C wherein a first side wall 20D (see FIG. 4) and a second side wall 20E is spaced apart from one another. Housing 20 also defines a cavity 20F by the top wall 20C and the pair of side walls 20D, 20E, collectively. The housing 20 also defines a front opening 20G by the top wall 20C and the pair of side walls 20D, 20E, collectively, and provides access into the cavity 20F at the front end 20A. The housing 20 also defines a bottom opening 20H by the pair of side walls 20D, 20E and provides access into the cavity 20F at a position vertically below the front opening 20G.

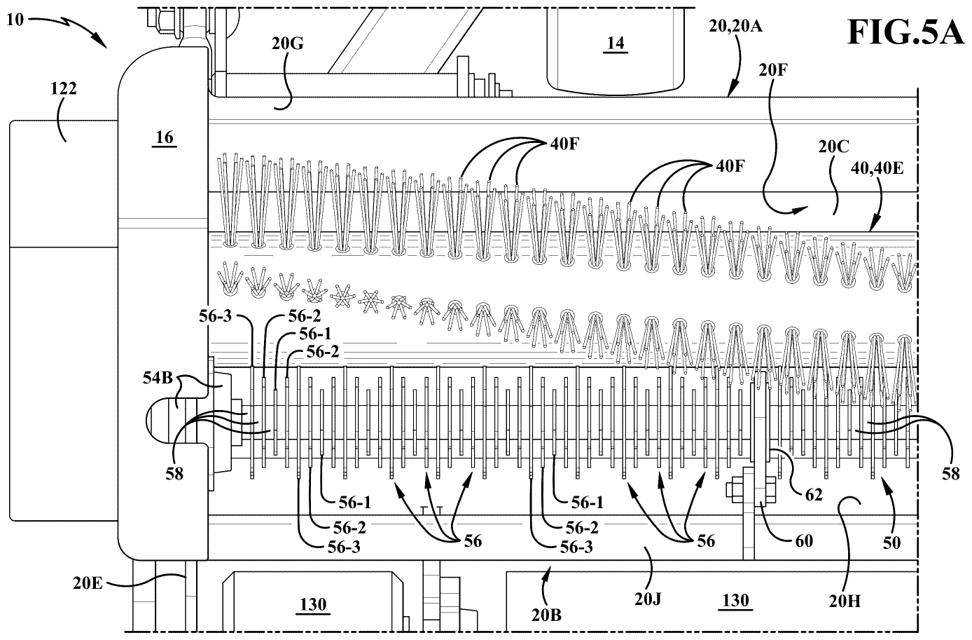

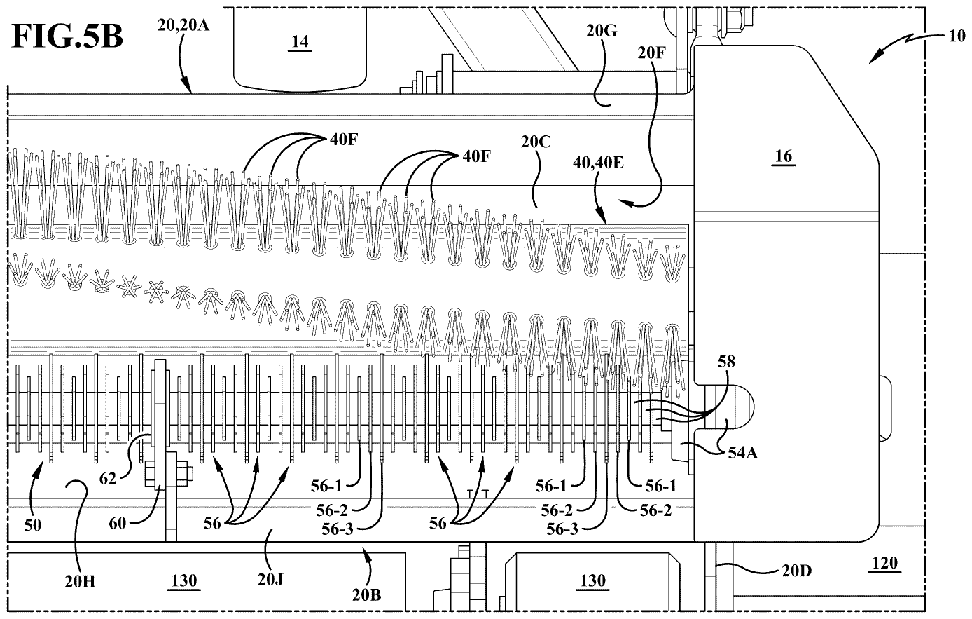

Housing 20 also includes a rear support bar 20J. As best seen in FIGS. 5A-5B, the rear support bar 20J extends between and engages with the first side wall 20D and the second side wall 20E. In the present disclosure, the rear support bar 20J is also positioned at the rear end 20B of the housing 20 while also being positioned inside of the cavity 20F. The rear support bar 20J is also positioned away from the front opening 20G. Such use and purpose of the rear support bar 20J with an auger assembly of the implement 10 is discussed in greater detail below.

Implement 10 also includes a power system or power take-off (PTO) generally referred to as 30. As best seen in FIG. 2, PTO 30 includes a primary PTO pulley 32 that operably engages with the PTO 6 of the vehicle 1 via a belt 34. Such engagement between the PTO 6 of the vehicle 1 and the primary PTO pulley 32 via the belt 34 allows the vehicle 1 to transfer rotational energy to the implement 10 to rotate a brush and an auger assembly of the implement 10, which are discussed in greater detail below. It should be understood that the term “primary” simply implies that PTO pulley 32 is the first or initial component or element that will receive the rotational force from the PTO 6 of the vehicle 1.

PTO 30 also includes a gearbox 36 that operably engages with the primary PTO pulley 32 by a connector or drive shaft (not shown) of the PTO 30. As best seen in FIG. 2, the primary PTO pulley 32 is upstream of the gearbox 36 so that the primary PTO pulley 32 may transfer rotational energy to the gearbox 36 that is received from and generated by the vehicle 1. Still referring to FIG. 2, the gearbox 36 also operably engages with a PTO drive shaft 38 that defines a rotational or drive axis 38A along the length of said PTO drive shaft 38. In the present disclosure, the primary PTO pulley 32 is oriented in a first direction relative to the gearbox 36 (i.e., facing away from the housing 20), and the PTO drive shaft 38 is oriented in a second direction relative to the gearbox 36 (i.e., facing towards the first side wall 20D) that is different than the first direction. In one exemplary embodiment, the first direction of the primary PTO pulley 32 and the second direction of the PTO drive shaft 38 are substantially orthogonal and/or non-parallel to one another. As such, the gearbox 36 transfers rotational energy from the primary PTO pulley 32 to the PTO drive shaft 38 in different directions.

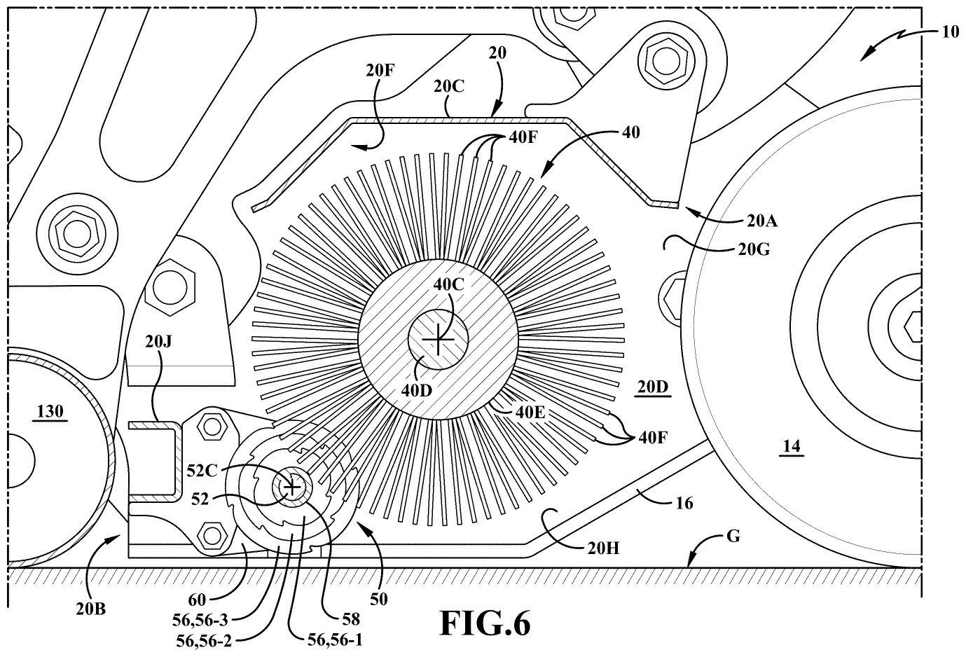

Implement 10 also includes a brush 40 that rotatably engages with the housing 20 and the PTO 30. As best seen in FIGS. 5A-5B, the brush 40 includes a first end 40A positioned proximate to the first side wall 20D, a second end 40B positioned proximate to the second side wall 20E and opposite to the first end 40A, and a longitudinal axis 40C defined therebetween (see FIG. 4B). As best seen in FIG. 6, the brush 40 is also substantially housed inside of the cavity 20F between the front opening 20G of the housing 20 and the bottom opening 20H of the housing 20.

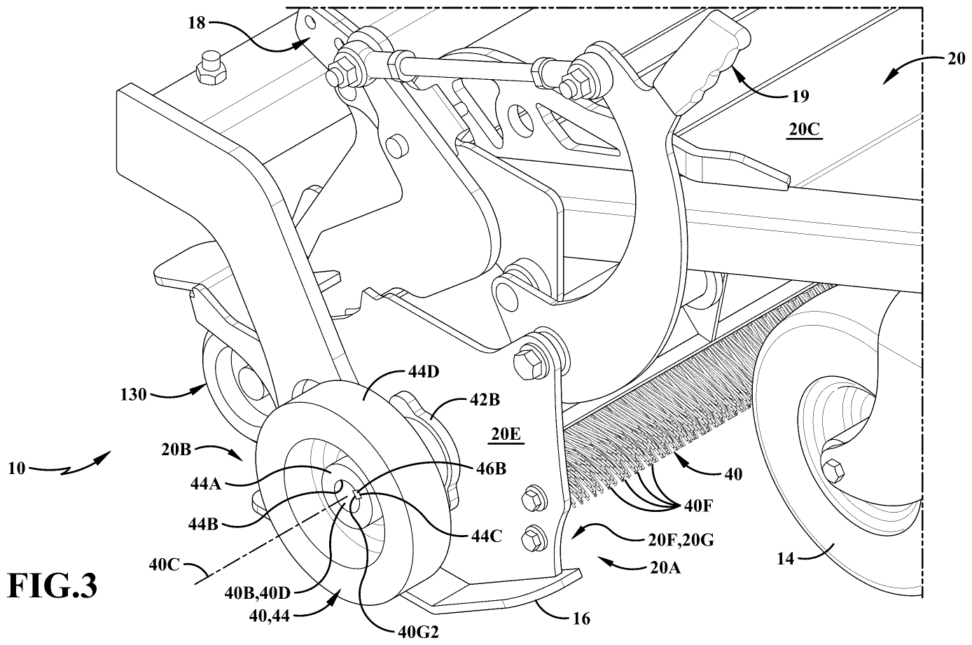

Still referring to brush 40, brush 40 includes a drive shaft 40D. As best seen in FIGS. 3-4, the drive shaft 40D extends longitudinally between the first end 40A of the brush 40 and the second end 40B of the brush 40. Referring to FIGS. 5A-6, the brush 40 also includes a barrel or rotor 40E extends between the first end 40A and the second end 40B and is disposed circumferentially about the drive shaft 40D. The brush 40 also includes a set of bristles 40F that extends radially outward from the barrel 40E at a length away from the barrel 40E. In the present disclosure, and as best seen in FIGS. 5A-5B, the set of bristles 40F is also positioned in a helical arrangement about the barrel 40E between the first end 40A and the second end 40B of the brush 40. Such helical arrangement is considered advantageous at least because at least one or more bristles of the set of bristles 40F may always contact and/or interact with one or more unwanted vegetation or weeds when operating the implement 10 on a lawn or turf area.

Still referring to brush 40, brush 40 may also defines a pair of keyways 40G1, 40G2 in one or more portions of the drive shaft 40D. As best seen in FIG. 4, a first keyway 40G1 is defined at a location along the drive shaft 40D measured between the first end 40A of the brush 40 to a location defined between the first end 40A and the second end 40B. As discussed in greater detail below, the first keyway 40G1 is configured to receive a key or similar device to secure a brush pulley of a brush drive system of the implement 10 with the brush 40 for rotating the brush 40. Similarly, and as best seen in FIG. 3, a second keyway 40G2 is defined at a location along the drive shaft 40D measured between the second end 40B of the brush 40 to a location defined between the first end 40A and the second end 40B. As discussed in greater detail below, the second keyway 40G2 is configured to receive a key or similar device to secure a fly wheel of the implement 10 with the brush 40 for conserving and/or storing rotational energy in the brush 40. In the present disclosure, the first keyway 40G1 and the second keyway 40G2 defined in the drive shaft 40D are spaced apart and remote from one another; as such, the first keyway 40G1 and the second keyway 40G2 are free from being in operative communication with one another.

The implement 10 also includes a pair of pillow bearing blocks 42A, 42B that rotatably engages with the brush 40 and is attached to the housing 20. As best seen in FIGS. 4A-4B, a first pillow bearing block 42A rotatably engages with the drive shaft 40D near the first end 40A of the brush 40 and attaches to the first side wall 20D, and a second pillow bearing block 42B rotatably engages with the drive shaft 40D near the second end 40B of the brush 40 and attaches to the second side wall 20E. Such use of the first pair of pillow bearing blocks 42A, 42B provides axial support to the drive shaft 40D as the brush 40 rotates about the longitudinal axis 40C; such operation of the brush 40 is discussed in greater detail below.

Implement 10 also includes a fly wheel 44 that operably engages with the brush 40. As best seen in FIG. 3, the fly wheel 44 includes an inner hub 44A that operably engages with the drive shaft 40D of brush 40. The inner hub 44A also defines a passageway 44B that extends entirely through the inner hub 44A along an axis or radial axis that is perpendicular to a circumferential path of the fly wheel 44. The inner hub 44A also includes a keyway 44C that is positioned inside of the passageway 44B and extends into the inner hub 44A. The fly wheel 44 also includes an outer hub or counterweight 44D that operably engages with the inner hub 44A. In the present disclosure, the outer hub 44D extends radially outward from the inner hub 44A.

Upon assembly, a first key 46A is installed between the drive shaft 40D of the brush 40 and a brush pulley to secure the brush 40 and the brush pulley with one another. More particularly, the first key 46A is engaged with the drive shaft 40D inside of the keyway 40H and with the brush pulley inside of a keyway defined by the brush pulley. Such engagement between the drive shaft 40D of the brush 40 and the brush pulley by the first key 46A retains the brush pulley with the brush 40 as the brush 40 rotates during operation of implement 10. Similarly, upon assembly, a second key 46B is installed between the drive shaft 40D of the brush 40 and the fly wheel 44 to secure the brush 40 and the fly wheel 44 with one another. More particularly, the second key 46B is engaged with the drive shaft 40D inside of the keyway 40H and with the inner hub 44A of the fly wheel 44 inside of the keyway 44C. Such engagement between the drive shaft 40D of the brush 40 and the fly wheel 44 by the second key 46B retains the fly wheel 44 with the brush 40 as the brush 40 rotates when operating implement 10.

Such inclusion of the fly wheel 44 at the second end 40B of the brush 40 is may conserve and/or store rotational energy along the brush 40 as the brush 40 is rotating. Such storage of rotational energy in the brush 40 is useful to prevent the implement 10 from generating a slower rotational speed and/or bogging down when the brush 40 experiences thick grass or turf. As such, the inclusion of the fly wheel 44 may remove unwanted mechanical stress from the motor of the vehicle 1 (which produces and outputs the rotational force to the implement 10) when implement 10 is traversing through various thicknesses or lengths of grass or turf. The inclusion of the fly wheel 44 is also considered advantageous at least because the fly wheel 44 smooths out and/or regulates the power curve of the brush 40 when in operation, As such, the brush 40 may rotate at a regulated and/or controlled rotational speed when traversing through various thicknesses or lengths of grass or turf.

In other exemplary embodiments, fly wheel 44 may be an optional component for implement 10. In one example, fly wheel 4 may be omitted or removed from implement 10 such that the brush 40 is free from engaging with a fly wheel 44 or similar device.

Implement 10 also includes an auger assembly (herein after “auger”) that is generally referred to as 50. In the present disclosure, certain components of auger 50, which are mentioned in further detail below, rotatably engages with the housing 20 and is substantially housed inside of the cavity 20F behind the brush 40 (see FIG. 5).

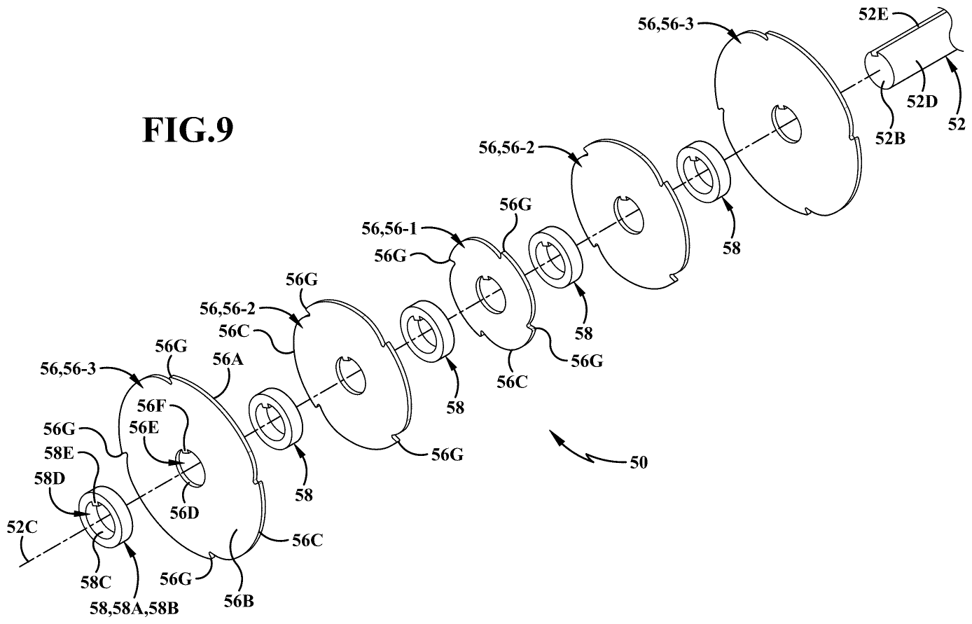

As best seen in FIGS. 4A, 5A-5B, and 7, the auger 50 includes a drive shaft 52 that has a first end 52A, a second end 52B opposite to the first end 52A, and a longitudinal axis 52C (see FIG. 4A) defined therebetween. The drive shaft 52 also includes an outer surface 52D that extends between the first end 52A and the second end 52B. The drive shaft 52 also defines a keyway 52E that extends along the entire length of the drive shaft 52 between the first end 52A and the second end 52B. In the present disclosure, the keyway 52E has a U-shaped cross-sectional shape when seen in a cross-sectional view (see FIG. 6) or a side view (see FIG. 9). In other exemplary embodiments, a keyway defined in a drive shaft of an auger assembly may define any suitable shape as dictated by the implementation of the keyway in the drive shaft.

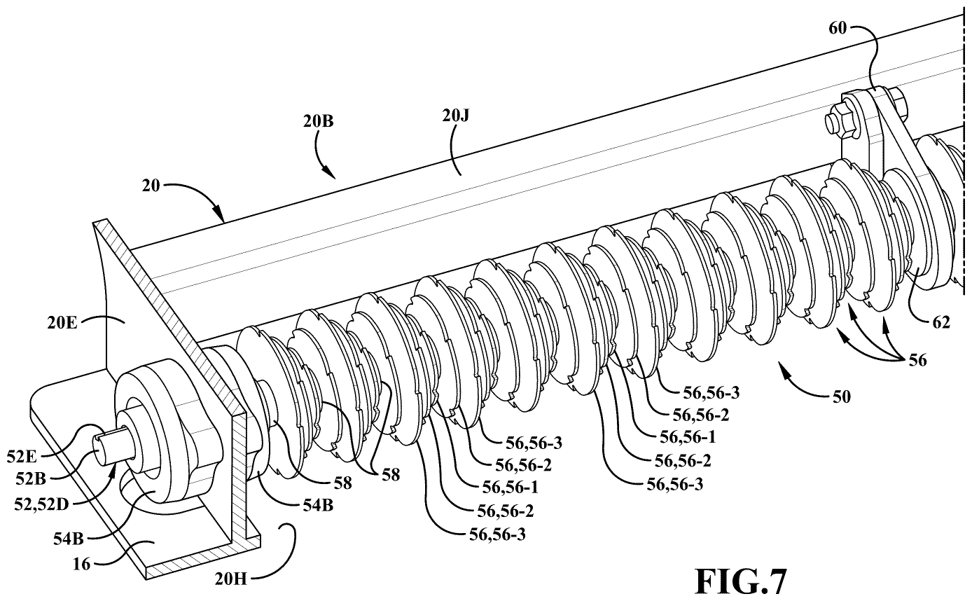

The drive shaft 52 also operably engages with pairs of pillow bearing blocks 54A, 54B that is attached to the housing 20. As best seen in FIGS. 4A and 7, a first pair of pillow bearing blocks 54A rotatably engages with the first end 52A of the drive shaft 52 and attaches to the first side wall 20D, and a second pair of pillow bearing blocks 54B rotatably engages with the second end 52B of the drive shaft 52 and attaches to the second side wall 20E. The pairs of pillow bearing blocks 54A, 54B may further be engaged with the drive shaft 52 inside of the keyway 52E in which a pin or key of each pillow bearing block of the pairs of pillow bearing blocks 54A, 54B is fixedly engaged with the drive shaft 52. Such use of the pairs of pillow bearing blocks 54A, 54B provides axial support to the drive shaft 52 as the drive shaft 52, along with additional components of the auger 50 engaged with the drive shaft 52, rotates about the longitudinal axis 52C; such operation of the auger 50 is discussed in greater detail below.

Auger 50 also includes at least one sets of blades 56. As best seen in FIG. 9, each blade of the sets of blades 56 includes a first side 56A, a second side 56B opposite to the first side 56A, an peripheral wall 56C that extends between the first side 56A and the second side 56B, and an inner wall 56D that extends between the first side 56A and the second side 56B and is internal to and remote from the peripheral wall 56C. Each blade of the sets of blades 56 also defines an opening 56E, by the inner wall 56D, that extends entirely through the blade 56 between the first side 56A and the second side 56B (see FIG. 9); the first side 56A and the second side 56B are in fluid communication with one another at the opening 56E. Each blade of the sets of blades 56 also includes a keyed portion 56F that extends outwardly from the inner wall 56D and into the opening 56E. Upon assembly, the keyed portion 56F of each blade of the sets of blades 56 is sized and configured to mechanically engage with the drive shaft 52 inside of the keyway 52E so that the sets of blades 56 is secured to the drive shaft 52.

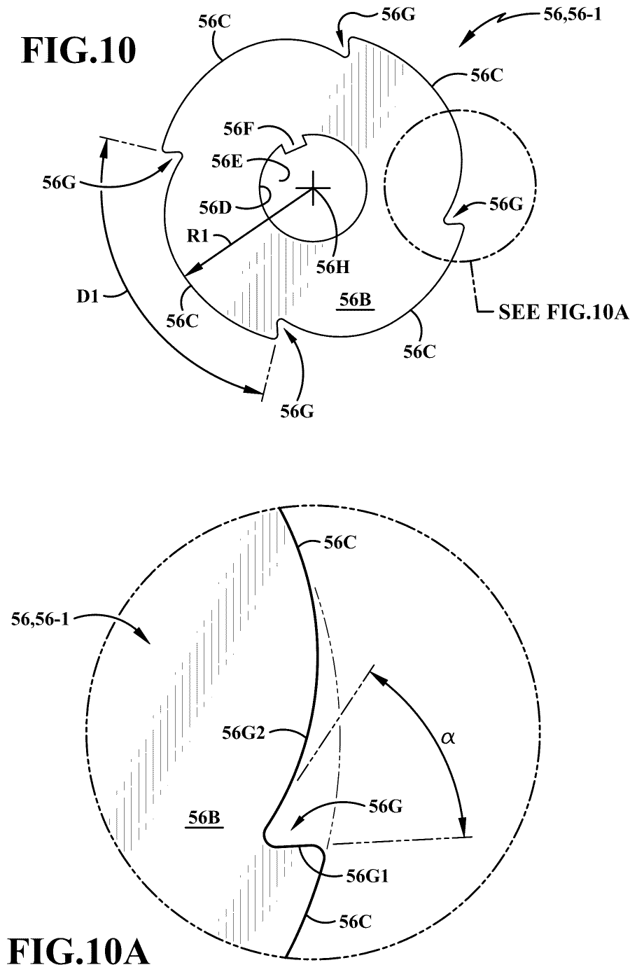

Each blade of the sets of blades 56 also defines a plurality of teeth 56G. As best seen in FIG. 10A, each tooth of the plurality of teeth 56G is defined along the peripheral wall 56C and is positioned between the first side 56A and the second side 56B. In a counterclockwise direction of the blade 56, each tooth of the plurality of teeth 56G includes a leading edge 56G1 that extends into the respective blade 56 from the peripheral wall 56C to a trailing edge 56G2. As such, the peripheral wall 56C is interrupted due to the inclusion of each tooth of the plurality of teeth 56G defined in a respective blade 56. In the present disclosure, each tooth of the plurality of teeth 56G also faces in the same direction in order to capture and striates weeds or unwanted vegetation while also pushing said weeds or unwanted vegetation into the brush 40 when operating implement 10, which is discussed in greater detail below.

Still referring to the plurality of teeth 56G, the leading edge 56G1 of each tooth of the plurality of teeth 56G is also defined at an angle a measured relative to the respective trailing edge 56G2. In one exemplary embodiment, a leading edge of each of a plurality of teeth may be defined at an angle within a range of 1 degree up to 90 degrees when measured relative to a respective trailing edge. In another exemplary embodiment, a leading edge of each of a plurality of teeth may be defined at an angle within a range of 45 degree up to 90 degrees when measured relative to a respective trailing edge. In another exemplary embodiment, a leading edge of each of a plurality of teeth may be defined at an angle approximately 90 degrees when measured relative to a respective trailing edge. The angle a at which the leading edge 56G1 of each tooth of the plurality of teeth 56G is defined relative to a respective trailing edge 56G2 may improve the capability of a given tooth of the plurality of teeth 56G to capture and striate a weed or similar component of an unwanted vegetation when the implement 10 is being used.

Each blade of the sets of blades 56 also defines a central axis 56H. As best seen in FIGS. 10 and 11-12, the central axis 56H extends between the first side 56A and the second side 56B. Upon assembly of the drive shaft 52 and the sets of blades 56, the central axis 56H of each blade of the sets of blades 56 is coaxial with the longitudinal axis 52C of the drive shaft 52 such that the drive shaft 52 and the sets of blades 56 share a common rotational axis.

It should be understood that auger 50 may include one or more sets of blades 56 that define different sizes, shapes, or configurations needed to capture and striate weeds or unwanted vegetation into the brush 40 when operating implement 10. In one instance, and as best seen in FIGS. 9-12, the auger 50 may include a first set of blades 56-1 that defines a first radius R1 measured from the central axis 56H to the peripheral wall 56C, a second set of blades 56-2 that defines a second radius R2 measured from the central axis 56H to the peripheral wall 56C, and a third set of blades 56-3 that defines a third radius R3 measured from the central axis 56H to the peripheral wall 56C. In this instance, the third radius R3 of each blade of the third set of blades 56-3 is greater than the second radius R2 of each blade of the second set of blades 56-2 and the first radius R1 of each blade of the first set of blades 56-1. In this same instance, the second radius R2 of each blade of the second sets of blades 56-2 is also greater than the first radius R1 of each blade of the first set of blades 56-1. Such radius variance between the first set of blades 56-1, second set of blades 56-2, and third set of blades 56-3 may increase the chances of capturing and destroying weeds and other similar unwanted vegetation of different sizes, shapes, and configurations from a ground surface when the vehicle 1 and the implement 10 traverse over the ground surface.

In the present disclosure, each blade of the sets of blades 56 discussed herein includes four teeth 56G defined along the peripheral wall 56C. In other exemplary embodiments, any suitable number of teeth defined in a blade discussed herein may be defined along an outer surface of a blade for capturing and striating weeds and other similar unwanted vegetation and pushing said weeds and other unwanted vegetation into a brush of an implement. Examples of suitable numbers of teeth that may be defined along an outer surface of a blade include one, at least one, two, a plurality, three, four, five, six, and other suitable numbers of teeth that may be defined along an outer surface of a blade for capturing and striating weeds and other similar unwanted vegetation and pushing said weeds and unwanted vegetation into a brush of an implement.

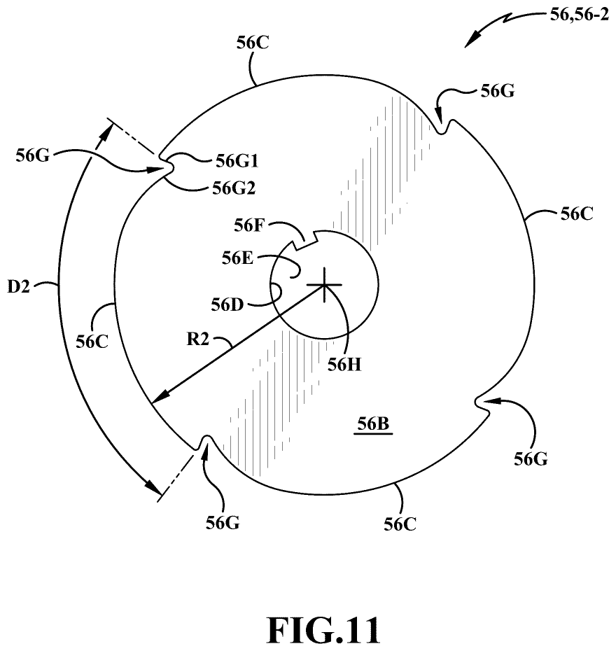

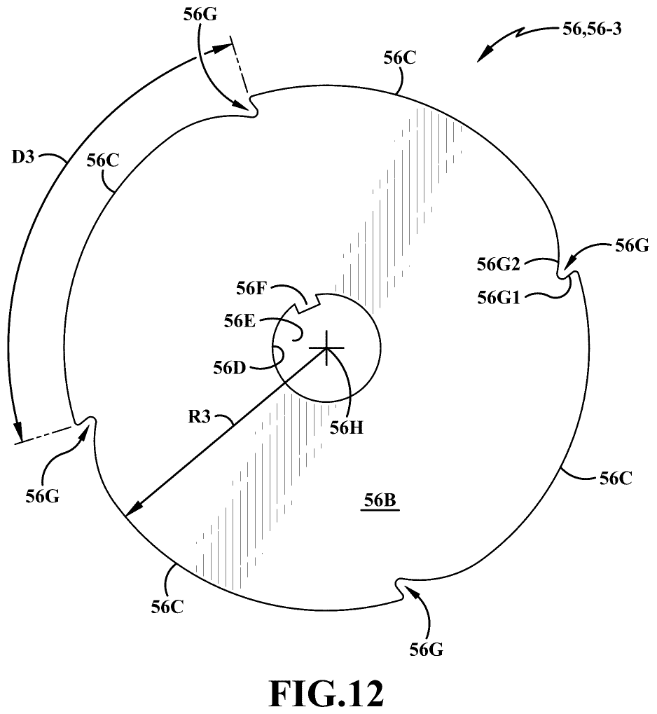

Each tooth of the plurality of teeth 56G for a specific blade 56 mentioned herein (e.g., blades 56-1, 56-2, 56-3) is also defined at a certain distance from an adjacent tooth of the plurality of teeth 56G. Particularly, the distance between two teeth of the plurality of teeth 56G is measured between the leading edges 56G 1 of the two teeth of the plurality of teeth 56G. In one instance, and as best seen in FIG. 10, each tooth of the plurality of teeth 56G for a blade of the first set of blades 56-1 is defined at a first distance D1 measured relative to an adjacent tooth of the plurality of teeth 56G. In another instance, and as best seen in FIG. 11, each tooth of the plurality of teeth 56G for a blade of the second set of blades 56-2 is defined at a second distance D2 measured relative to an adjacent tooth of the plurality of teeth 56G; the second distance D2 is greater than the first distance D1. In another instance, and as best seen in FIG. 12, each tooth of the plurality of teeth 56G for a blade of the third set of blades 56-3 is defined at a third distance D3 measured relative to an adjacent tooth of the plurality of teeth 56G; the third distance D3 is greater than the second distance D2 and the first distance D1.

In the present disclosure, each blade of the sets of blades 56 defines a two-dimensional circular shape when viewed from a side elevation view (see FIGS. 10 and 11-12). In other exemplary embodiments, each blade of a sets of blades described herein may define any two-dimensional shape that is suitable for capturing weeds and other similar unwanted vegetation from a ground surface. Examples of suitable two-dimensional shapes for each blade of a sets of blades include round, curvilinear, square, rectangular, triangular, pentagonal, hexagon, octagon, polygonal, and other suitable two-dimensional shapes that assist in capturing weeds and other similar unwanted vegetation from a ground surface.

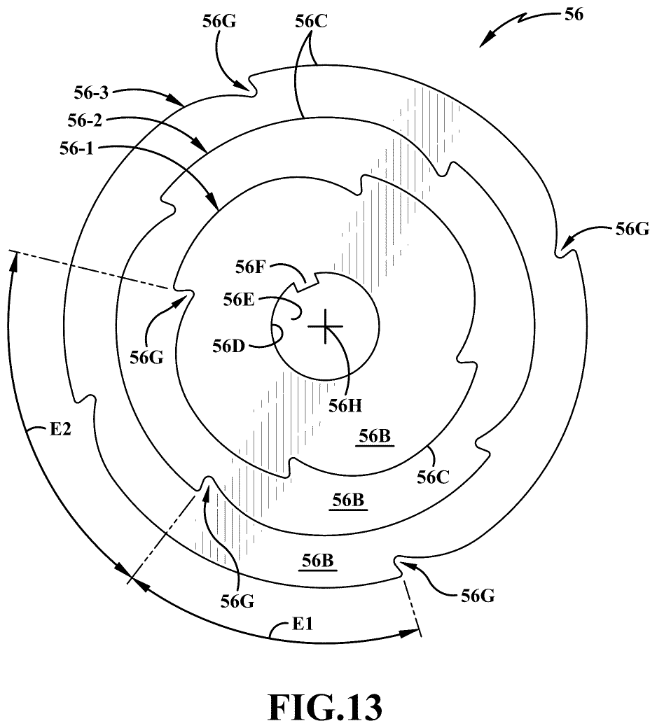

Upon assembly, the keyed portion 56F of each blade of the sets of blades 56-1, 56-2, 56-3 is sized and configured to engage with the drive shaft 52 inside of the keyway 52E so that the sets of blades 56-1, 56-2, 56-3 are secured to the drive shaft 52. Once engaged, the plurality of teeth 56G for each blade of the sets of blades 56-1, 56-2, 56-3 is staggered and/or offset. As best seen in FIG. 13, the plurality of teeth 56G of a blade of the first set of blades 56-1 is staggered and/or offset to the plurality of teeth 56G of a blade of the second set of blades 56-2 which is adjacent to the blade the first set of blades 56-1. As shown in FIG. 13, a first offset distance E1 is measured between the leading edge 56G1 of a tooth of the plurality of teeth 56G of the blade of the first set of blades 56-1 and the leading edge 56G1 of a tooth of the plurality of teeth 56G of the blade of the second set of blades 56-2. Similarly, and as best seen in FIG. 13, the plurality of teeth 56G of the blade of the second set of blades 56-2 is also staggered and/or offset to the plurality of teeth 56G of a blade of the third set of blades 56-3 which is adjacent to the blade the second set of blades 56-2. As shown in FIG. 13, a second offset distance E2 is measured between the leading edge 56G 1 of a tooth of the plurality of teeth 56G of the blade of the second set of blades 56-2 and the leading edge 56G1 of a tooth of the plurality of teeth 56G of the blade of the third set of blades 56-3. In this particular instance, the first offset distance E1 is greater than the second offset distance E2. In other exemplary embodiments, any suitable offset distances may be defined between adjacent blades of sets of blades mentioned herein. In one example, a first offset distance as mentioned herein may be equal to a second offset distance as mentioned herein. In another example, a first offset distance as mentioned herein may be less than a second offset distance as mentioned herein.

Auger 50 also includes set of spacers 58 that operably engage with the drive shaft 52 and is positioned between the sets of blades 56. As best seen in FIG. 9, each spacer of the set of spacers 58 includes a tubular wall 58A, an outer surface 58B that extends along the length of the tubular wall 58A, an inner surface 58C that extends along the length of the tubular wall 58A and is opposite to the outer surface 58B, and a passageway 58D defined by the inner surface 58C. Each spacer of the set of spacers 58 also includes a keyed portion 58E that extends radially outward from the inner surface 58C and into the passageway 58D.

Upon assembly, the keyed portion 58E of each spacer of the set of spacers 58 is sized and configured to engage with the drive shaft 52 inside of the keyway 52E so that the set of spacers 58 is secured to the drive shaft 52. Upon assembly, a spacer of the set of spacers 58 is positioned between a pair of blades of the sets of blades 56 in which each pair of blades 56 is spaced apart from one another. Such spaced configuration of the sets of blades 56 may improve the capability of each blade of the sets of blades to capture and push one or more weeds or similar unwanted vegetation from a ground surface into the brush 40 when operating implement 10 over a lawn or turf area.

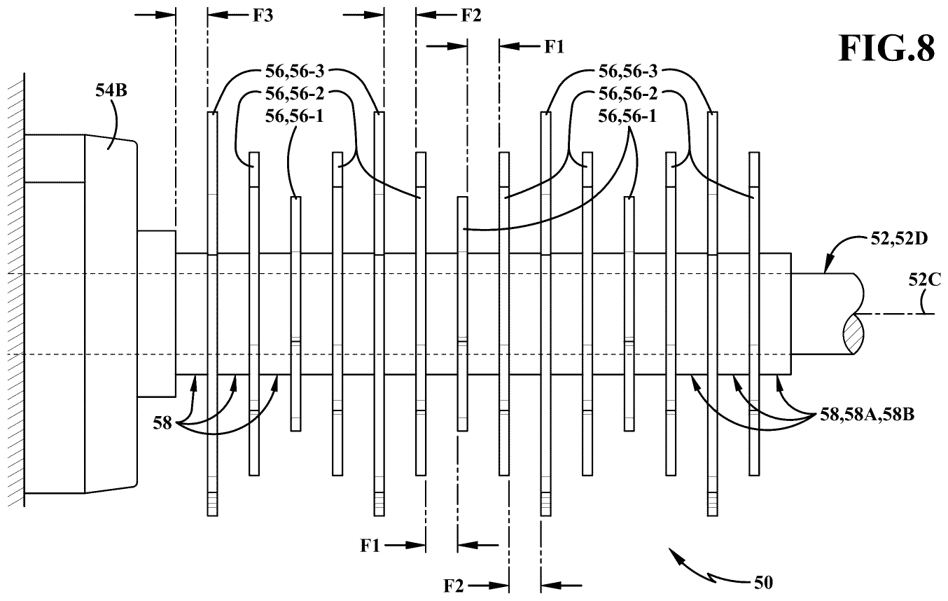

Upon assembly of the drive shaft 52, the sets of blades 56-1, 56-2, 56-3, and the set of spacers 58, the sets of blades 56-1, 56-2, 56-3 may also be laterally spaced apart from one another due to the lengths of each spacer of the set of spacers 58. As best seen in FIG. 8, a blade of the first set of blades 56-1 and an adjacent blade of the second set of blades 56-2 define a first lateral distance F1 measured between one another. Similarly, and as best seen in FIG. 8, another blade of the second set of blades 56-2 and an adjacent blade of the third set of blades 56-3 define a second lateral distance F2 measured between one another. Still referring to FIG. 8, the outermost blade of the third set of blades 56-3 and a pillow bearing block of the second pair of pillow bearing blocks 54B also define a third lateral distance F3 measured between one another. In the present disclosure, the first lateral distance F1, the second lateral distance F2, and the third lateral distance F3 are equal to one another due to each spacer of the set of spacers 58 having a uniform length. In other exemplary embodiments, the first lateral distance F1, the second lateral distance F2, and the third lateral distance F3 mentioned herein may be any suitable distance based on various considerations, including overall length of each spacer of the set of spacers 58, the overall thickness of each blade of a set of blades, and other various considerations.

Auger 50 also includes a set of support brackets 60. As best seen in FIGS. 5A-5B and 7, each support bracket of the set of support brackets 60 operably engages with the rear support bar 20J between the pair of side walls 20D, 20E. In the present disclosure, each support bracket of the set of support brackets 60 extends forwardly from the rear support bar 20J towards the brush 40. With such configuration, the drive shaft 52 of the auger 50 is suspended and/or cantilevered at one or more location between the first end 52A and the second end 52B to provide additional strength and rigidity to the drive shaft 52 as the drive shaft 52 rotates and interferes with weeds and other similar unwanted vegetation.

Auger 50 also includes a bearing 62 that is housed inside each support bracket of the set of support brackets 60. As best seen in FIG. 7, each bearing 62 operably engages with a portion of outer surface 52D of the drive shaft 52 to provide axial and/or rotational support to the drive shaft 52. In one exemplary embodiment, each bearing 62 provided in the auger 50 is a rolling bearing that includes either balls or rollers. In other exemplary embodiments, any suitable bearing may be used herein to provide axial and/or rotational support to the drive shaft 52. With this configuration, the drive shaft 52 of the auger 50 is also axially supported by the bearings 62 between the first end 52A and the second end 52B when the drive shaft 52 is rotating at a specific speed or rate of rotation.

It should be understood that any suitable number of support brackets 60 and bearings 62 may be used in the auger assembly to cantilever the drive shaft 52 at one or more location and to axial support the drive shaft the same one or more locations. Examples of suitable numbers of support brackets and bearings that may be used to support a drive shaft of an auger assembly mentioned herein includes one, at least one, two, plurality, three, four, five, six, and any other suitable numbers of support brackets and bearings to support a drive shaft of an auger assembly. In the present disclosure, the auger 50 includes three support brackets 60 with a bearing 62 provided in each of the three support brackets 60.

The structural arrangement between the brush 40 and the auger 50 is considered advantageous at least because the brush 40 and the auger 50 collectively work together to lift and eviscerate one or more unwanted vegetation from a desired lawn or turf. Initially, and as discussed in greater detail below, the sets of blades 56 of the auger 50 capture and/or grab one or more unwanted vegetation from a desired lawn or turf. Once the unwanted vegetation is captured, the auger 50 is then configured to lift and rotate the unwanted vegetation into the set of bristles 40F of the brush 40 to striate and slice the unwanted vegetation into smaller pieces. Such eviscerated and/or destroyed vegetation may be left behind on the lawn or turf so that the unwanted vegetation is no longer rooted into the lawn or turf without use of harmful pesticides and/or similar chemicals.

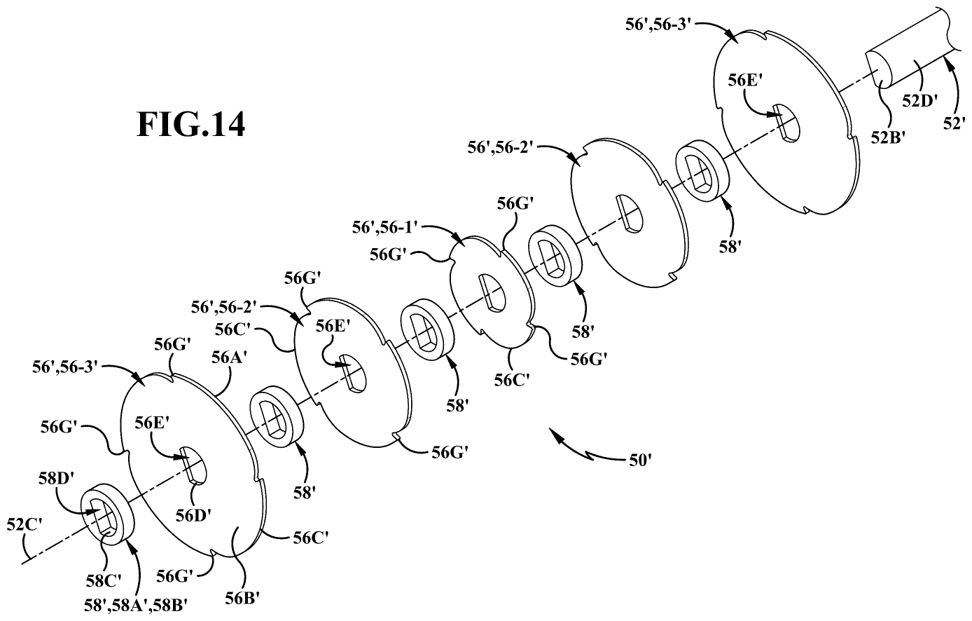

In another embodiment, implement 10 may utilize another auger assembly 50′ (hereinafter “auger” 50) (see FIG. 14) that is similar to auger 50 discussed above and illustrated in FIGS. 7-13, except as discussed below. It should be understood that the capabilities of auger 50′ are identical to the auger 50 discussed above in capturing and/or catching weeds and other unwanted vegetation rooted in lawns and other turf areas. Such features and components of auger 50′ are now discussed below.

Referring to FIG. 14, auger 50′ includes a drive shaft 52′ that is substantially similar to drive shaft 52 of auger 50. Particularly, drive shaft 52′ includes a first end (not illustrated), a second end 52B′ longitudinally opposite to the first end, and a longitudinal axis 52C′ that are similar to the first end 52A, second end 52B, and longitudinal axis 52C of the auger 50. In this embodiment, however, drive shaft 52′ includes an outer surface 52D′ that extends between the first end and second end 52B′ along the longitudinal axis 52C′ while defining a D-shaped outer profile. When viewed from a side elevation view (see FIG. 14), the outer surface 52D′ defines a continuous and uninterrupted flat or planar wall that extends between the first and second ends of the drive shaft 52′; such use and purpose of the outer surface 52D′ of the drive shaft 52′ is discussed in greater detail below. Moreover, drive shaft 52′ omits any keyway or slot (such as keyway 52E) due to the D-shaped configuration of the outer surface 52D.

Still referring to FIG. 14, auger 50′ also includes sets of blades 56′ that are similar to the sets of blades 56 of auger 50. Particularly, each blade of the sets of blades 56′ includes a first side 56A′, a second side 56B′, a peripheral wall 56C′, a plurality of teeth 56G′ where each tooth includes a leading edge 56G1′ and a trailing edge 56G2′, and a central axis 56H′ that are similar to first side 56A, second side 56B, peripheral wall 56C, the plurality of teeth 56G where each tooth includes leading edge 56G1 and trailing edge 56G2, and central axis 56H of each blade of the sets of blades 56. In this embodiment, however, each blade of the sets of blades 56′ includes an inner wall 56D′ that defines a D-shaped inner profile that matches with and/or corresponds to the D-shaped outer profile of the outer surface 52D′ of the drive shaft 52′. With such configuration, the inner wall 56D′ also defines a D-shaped opening 56E′ so that each blade of the sets of blades 56′ may receive and engage with the drive shaft 52′ and is prevented from axially rotating about the outer surface 52D′ of the drive shaft 52′. With such configuration, each blade of the sets of blades 56′ is free from including a keyed portion (such as keyed portion 56F) or similar component that would engage with a keyway or slot defined in a drive shaft.

Still referring to FIG. 14, auger 50′ also includes set of spacers 58′ that is similar to the set of spacers 58 of auger 50. Particularly, each spacer of the set of spacers 58′ includes a tubular wall 58A′ and an outer surface 58B′ that is similar to the tubular wall 58A and the outer surface 58B of each spacer of the set of spacers 58. In this embodiment, however, each spacer of the set of spacers 58′ includes an inner surface 58C′ that defines a D-shaped inner profile that matches with and/or corresponds to the D-shaped outer profile of the outer surface 52D′ of the drive shaft 52′. With such configuration, the inner surface 58C′ also defines a D-shaped passageway 58D′ so that each spacer of the set of spacers 58′ may receive and engage with the drive shaft 52′and is prevented from axially rotating about the outer surface 52D′ of the drive shaft 52′. With such configuration, each spacer of the set of spacers 58′ is free from including a keyed portion (such as keyed portion 58E) or similar component that would engage with a keyway or slot defined in a drive shaft.

While auger 50′ utilizes D-shaped structural configurations for the drive shaft 52′, the sets of blades 56′, and the set of spacers 58′, any auger discussed herein may include a drive shaft, sets of blades, and a set of spacers that have any suitable structural configurations and/or profiles for securing with one another. As such, the drive shaft 52′, the sets of blades 56′, and the set of spacers 58′ of auger 50′ may take the form of any shape; thus, it is to be understood that any other geometric configuration of that element, component, or structure is entirely possible. For example, instead of using D-inner and/or outer profiles for the drive shaft 52′, the sets of blades 56′, and the set of spacers 58′, the drive shaft 52′, the sets of blades 56′, and the set of spacers 58′may have any suitable inner and/or outer profile shape, including semi-circular triangular inner or outer profiles, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Implement 10 also includes a first or brush drive system 70 that operably engages with the PTO 30 of implement 10. As best seen in FIG. 4C, the brush drive system 70 includes a PTO brush pulley 72 that operably connects with the PTO drive shaft 38 of the PTO 30. The brush drive system 70 also includes a first jockey pulley 74 that is downstream of the PTO brush pulley 72. In operation, the first jockey pulley 74 is configured to apply tension along brush belt B1 of the brush drive system 70 directly after the PTO brush pulley 72.

Still referring to the brush drive system 70, the brush drive system 70 also includes a second jockey pulley 76 that is downstream of the first jockey pulley 74 (see FIG. 4C). In operation, the second jockey pulley 76 is configured to apply tension along brush belt B1 of the brush drive system 70 directly after the first jockey pulley 74. The brush drive system 70 also includes a brush pulley 78 that operably connects with the drive shaft 40D at the first end 40A of the brush 40 (see FIG. 4C). As discussed previously, the first key 46A secures the drive shaft 40D of the brush 40 and the brush pulley 78 with one another. In the present disclosure, the brush pulley 78 is also downstream to the first jockey pulley 74 and second jockey pulley 76 and is configured to transfer rotational energy to the brush 40 received from the second jockey pulley 76.

Brush drive system 70 also includes a tensioner 80 that operably engages with the housing 20. As best seen in FIG. 4D, the tensioner 80 includes a tension arm 82 that rotatably engages with the first side wall 20D of the housing 20 and is external to the cavity 20F. Still referring to FIG. 4D, the tension arm 82 includes a first end 82A, a second end 82B opposite to the first end 82A, a tubular member 82C that extends outwardly from the tension arm 82 at the second end 82B, and a pair of bushings (not shown herein) housed inside of the tubular member 82C.

Still referring to the tensioner 80, the tensioner 80 also includes a pivot mechanism 84 that pivotably engages the tension arm 82 with the first side wall 20D of housing 20 (see FIG. 4D). In one example, the pivot mechanism 84 includes a fastener that passes through the tension arm 82 and the first side wall 20D and threadably engages with an associated nut. In this same exemplary embodiment, the pivot mechanism 84 may also include a sleeve that covers the fastener (particularly threads of the fasteners) so that the bushings ride about the sleeve and rotate the tension arm 82 without any obstructions from the fastener.

Still referring to the tensioner 80, the tensioner 80 also includes a support mechanism 86 that operably engages with housing 20 and a support plate 87. In one example, the support mechanism 86 may include a fastener that passes through a bottom end 87B of the support plate 87 of the tensioner 80 and the first side wall 20D and threadably engages with an associated nut (see FIG. 4D). The support mechanism 86 may also include a sleeve that covers the fastener (particularly threads of the fasteners). It should be noted that the support plate 87 also operably engages with the tension arm 82 at a top end 87A above the support mechanism 86 (see FIG. 4D).

Still referring to tensioner 80, tensioner 80 includes a first biaser 88 that operably engages with the tension arm 82 and the support mechanism 86. As seen in FIG. 4D, the first biaser 88 operably engages with the tension arm 82 at a first position (at a location between the first end 82A and the second end 82B that is closer to the second end 82B) and at a second position (along the tubular member 82C). The first biaser 88 also operably engages with a retention plate 89 that is positioned behind the tension arm 82 so that the first biaser 88 is retains a desired bias on the tension arm 82. Such positioning and engagement of the first biaser 88 enables the tension arm 82 to be biased in a given direction to apply a desired tension along the brush belt B1. In the present disclosure, the first biaser 88 enables the tension arm 82 to be biased in a forward direction (towards the front opening 20G of housing 20) to apply a desired tension along the brush belt B1.

Brush drive system 70 also includes a tension pulley 90 and a third jockey pulley 92. As best seen in FIGS. 4C-4D, the tension pulley 90 operably engages with the tension arm 82 at the first end 82A, and the third jockey pulley 92 operably engages with the support plate 87 adjacent to the second end 82B of the tension arm 82. As such, the tension pulley 90 and the third jockey pulley 92 are spaced apart from one another and positioned opposite to one another. In the present disclosure, the tension pulley 90 is also positioned vertically above the third jockey pulley 92. Such engagement with the tension arm 82 enables at least the tension pulley 90 to rotatably move with tension arm 82 based on the biasing characteristics of the first biaser 88. It should be noted that third jockey pulley 92 is downstream of the brush pulley 78, and the tension pulley 90 is downstream of the third jockey pulley 92 in which the third jockey pulley 92 is intermediate to the brush pulley 78 and the tension pulley 90. With this configuration, tension pulley 90 is configured variable tension along brush belt B1 of the brush drive system 70 downstream of the brush pulley 78.

It should be understood that the pulleys 72, 74, 76, 78, 90, 92 of the brush drive system 70 may be any type of pulley that may engage with the brush belt B1 and may transfer rotational energy between downstream pulleys. In one exemplary embodiment, any pulley of the brush drive system 70 discussed herein may be a V-groove style pulley that engages with a brush belt and transfers rotational energy between downstream pulleys. In another exemplary embodiment, any pulley of the brush drive system 70 discussed herein may be a step style pulley that engages with a brush belt and transfers rotational energy between downstream pulleys. In another exemplary embodiment, any pulley of the brush drive system 70 discussed herein may be a cone style pulley that engages with a brush belt and transfers rotational energy between downstream pulleys.

Implement 10 also includes a second or auger drive system 100 that operably engages with the PTO 30 of implement 10. As best seen in FIG. 4A, the auger drive system 100 includes a PTO auger pulley 102 that operably connects with the PTO drive shaft 38 of the PTO 30. The auger drive system 100 also includes a first jockey pulley 104 that is downstream of the PTO auger pulley 102. As discussed in greater detail below, the first jockey pulley 104 is configured to apply tension along an auger belt B2 of the auger drive system 100 directly after the PTO auger pulley 102.

Auger drive system 100 also includes a second jockey pulley 106 that is downstream of the first jockey pulley 104 (see FIG. 4A). As discussed in greater detail below, the second jockey pulley 106 is configured to apply tension along auger belt B2 of the auger drive system 100 directly after the first jockey pulley 104. Auger drive system 100 also includes an auger pulley 108 that operably connects with the drive shaft 52 at the first end 52A of the auger 50 (see FIG. 4A). In the present disclosure, the auger pulley 108 is downstream of the second jockey pulley 106 while being configured to transfer rotational energy to the drive shaft 52 (and all components of the auger 50 that rotate with the drive shaft 52) received from the second jockey pulley 106.

Auger drive system 100 also includes a tensioner 110 that operably engages with the housing 20. As best seen in FIG. 4B, the tensioner 110 includes a tension arm 112 that rotatably engages with the first side wall 20D of the housing 20 and is external to the cavity 20F. Still referring to FIG. 4B, the tension arm 112 includes a first end 112A, a second end 112B opposite to the first end 112A, a tubular member 112C that extends outwardly from the tension arm 112 at the second end 108B, and a pair of bushing (not illustrated) housed inside of the tubular member 108C.

In the present disclosure, the tensioner 110 of the auger drive system 100 shares parts and/or components with the tensioner 80 of the brush drive system 70. Particularly, the pivot mechanism 84 discussed above are used in the both the brush drive system 70 and the auger drive system 100. In this particular embodiment, the tension arm 82 of the tensioner 80 of the brush drive system 70 and the tension arm 112 of the tensioner 110 of the auger drive system 100 rotatably engage with the pivot mechanism 84 at two different positions. Additionally, a second biaser of the auger drive system 100, which is discussed in greater detail below, also operably engages with the pivot mechanism 84 similar to the first biaser 88 of the tensioner 80 of the brush drive system 70.

Still referring to tensioner 110, tensioner 110 includes a second biaser 114 that operably engages with the tension arm 112 and the pivot mechanism 84. As best seen in FIG. 4B, the second biaser 114 operably engages with the tension arm 112 at a first position (at a location between the first end 112A and the second end 112B that is closer to the second end 112B) and at a second position (along the tubular member 112C). The second biaser 114 also operably engages with retention plate 89 that is positioned behind the tension arm 112 so that the second biaser 114 retains a desired bias on the tension arm 112; it should be understood that the retention plate 89 discussed above is also shared with the auger drive system 100. Such positioning and engagement of the second biaser 114 enables the tension arm 112 to be biased in a given direction to apply a desired tension along the auger belt B2. In the present disclosure, the second biaser 114 enables the tension arm 112 to be biased in a forward direction (towards the front opening 20G of housing 20) to apply a desired tension along the auger belt B2.

Auger drive system 100 also includes a tension pulley 116 that operably engages with the tensioner 110. As best seen in FIG. 4B, tension pulley 116 operably engages with the tension arm 112 at the first end 108A. Such engagement with the tension arm 112 enables the tension pulley 116 to rotatably move with tension arm 112 based on the biasing characteristics of the second biaser 114. It should be noted that the tension pulley 116 is downstream of the auger pulley 108 and is configured variable tension along auger belt B2 of the auger drive system 100 directly after the auger pulley 108.

In the present disclosure, the brush drive system 70 and the auger drive system 100 may rotate and/or spin the brush 40 and the auger 50, particularly the drive shaft 52 and sets of blades 56, at a desired rate or speed (e.g., revolutions per minute (RPM)). In one instance, the brush drive system 70 is configured to rotate the brush 40 at a first speed of rotation or a first rotational speed, and the auger drive system 100 is configured to rotate the drive shaft 52 and sets of blades 56 at a second speed of rotation or second rotational speed; the first speed of rotation and the second speed of rotation are different from one another. More particularly, the brush drive system 70 is configured to rotate the brush 40 at the first speed of rotation, and the auger drive system 100 is configured to rotate the drive shaft 52 and sets of blades 56 at the second speed of rotation that is greater than the first speed of rotation. Specifically, the second speed of rotation generated by the auger drive system 100 is three time greater than the first speed of rotation generated by the brush drive system 70 (i.e., a speed rotation of 3:1). Specifically, the first speed of rotation of the brush 40 is variable and is limited to about 1600 RPMs by the brush drive system 70. The second speed of rotation of the auger 50 is also variable and is limited to about 4800 RPMs by the auger drive system 100. Furthermore, the brush drive system 70 and the auger drive system 100 may also be configured to allow the brush 40 and the auger 50 to spin and/or rotate so that the velocities of the lateral surfaces of the brush 40 and the auger 50 are matched with one another.

In the present disclosure, the brush drive system 70 and the auger drive system 100 are both belt-driven system. In other exemplary embodiments, the brush drive system 70 and the auger drive system 100 mentioned herein may be operated by other drive means for rotating the brush 40 and the auger 50. In one exemplary embodiment, a brush drive system and an auger drive system mentioned herein may be chain-drive system for rotating a corresponding brush and a corresponding auger assembly. In one exemplary embodiment, a brush drive system and an auger drive system mentioned herein may be gear-drive system for rotating a corresponding brush and a corresponding auger assembly. In one exemplary embodiment, a brush drive system and an auger drive system mentioned herein may be cable-drive system for rotating a corresponding brush and a corresponding auger assembly.

Implement 10 may also include a first shroud or guard 120 and a second shroud or guard 122 (see FIG. 2). In the present disclosure, the first shroud 120 operably engages with the housing 20, particularly with the first side wall 20D of the housing 20, for protecting the brush drive system 70 and the auger drive system 100. For reference, the first shroud 120 protects and shields the brush drive system 70 and the auger drive system 100 shown in FIG. 4 when the first shroud 120 is engaged with the housing 20. Similarly, the second shroud 122 operably engages with the housing 20, particularly with the second side wall 20E of the housing 20, for protecting components of the brush 40, the flywheel 44, and the auger 50. For reference, the second shroud 122 protects and shields components of the brush 40, the flywheel 44, and the auger 50 shown in FIG. 3 when the second shroud 122 is engaged with the housing 20.

Implement 10 may also include a roller kit 130. As best seen in FIGS. 1-2, the roller kit 130 is positioned behind the brush 40 and the auger 50 and outside of the cavity 20F of the housing 20. In operation, the roller kit 130 may be configured to press and lay a desired amount of lawn or turf in the direction at which the vehicle 1 and the implement 10 are traveling. It should be understood that the roller kit 130 is primarily used to level and hold the implement 10 as the implement 10 traverses along the lawn or turf and as to the brush 40 and the auger 50 capture and destroy unwanted vegetation from the lawn or turf.

With respect to the roller kit 130, any suitable number of rollers may be included with roller kit 130. In the present disclosure, a single roller is included with roller kit 130 for leveling and holding the implement 10 as the implement 10 traverses along the lawn or turf. In other exemplary embodiments, any suitable number of rollers may be included with a roller kit 130 mentioned herein where the rollers may vary in size or shape depending on the implementation of such rollers with implement 10.

Having now discussed the systems, assemblies, and components of the implement 10, a method of damaging and/or destroying weeds and other unwanted vegetation rooted in lawn or turf areas by the implement 10 is discussed in greater detail below.

Prior to operating the implement 10, an operator of the vehicle 1 and implement may initially engage the attachment frame assembly 12 with the frame 2 of the vehicle 1 so that the implement 10 may travel and traverse with the vehicle 1. The operator may then adjust the operating height of the implement 10 to suit the length of the lawn or vegetation at which the implement 10 will be traversing; such adjustment of the operating height is performed by moving the adjustment mechanisms 19 to a suitable position along the frame components 18. In one particular embodiment, the operating height of the implement 10 may be set to about one-third of a mowing height of a mowing unit or implement relative to each blade of the second set of blades 56-2; such operating height is denoted by a double arrow labeled “H” measured from the ground surface “G” to the peripheral wall 56C of the blade 56-2 in FIG. 15A. For example, the operating height of the implement 10 would be about one inch measured from the ground surface “G” to the peripheral wall 56C of the blade 56-2 when the mowing height is about three inches. In other exemplary embodiments, the operating height of the implement 10 may be any other suitable height or depth that is below or lower than a desired mowing height of a mowing unit or implement that is used after the implement 10 has traversed the selected lawn or turf area. The operating height will collectively move the brush 40 and auger 50 to the selected operating height so that the implement 10 captures and separates weeds and other unwanted vegetation from a ground surface.

It should also be understood that such operation of the implement 10 occurs prior to such lawn or turf area being mowed. As best seen in FIG. 15A, the lawn or turf area includes a lawn height “LH” that is greater than the operational height “H” of the implement 10 for damaging and/or destroying weeds and other unwanted vegetation. As such, the mowing height will be less than or shorter than the lawn height “LH” depicted herein.

The operator may also engage the belt 34 of the PTO 30 with the PTO 6 of the vehicle 1 in order for the vehicle 1 to transfer rotational energy from the vehicle 1 to the implement 10; it should be noted that such rotational energy is generated by the vehicle 1 through conventional mechanisms and/or devices (e.g., a motor of the vehicle 1 that generates the rotational energy). Once the implement 10 is engaged with the frame 2 and the PTO 6 of the vehicle 1, the operator may traverse a ground surface with the implement 10 to damage and/or destroy weeds and other unwanted vegetation from a ground surface.

Prior to operating the implement 10 for damaging and/or destroying weeds and other unwanted vegetation from a ground surface, the operator may initiate the PTO 6 of the vehicle 1 to rotate both the brush 40 and the auger 50. In operation, the PTO 6 of the vehicle 1 applies rotational energy on the PTO 30 of the implement 10 by the belt 34. Based on this configuration, the belt 34 then transfers the rotational energy along the components of the PTO 30, including the primary PTO pulley 32, the gearbox 36, and the PTO drive shaft 38. Once the rotational energy reaches the PTO drive shaft 38, the PTO drive shaft 38 transfers the rotational energy to each of the brush drive system 70 and the auger drive system 100 to rotate the brush 40 and the auger 50 at different speeds of rotation.

With respect to the brush drive system 70, the PTO drive shaft 38 transfers the rotational energy to the PTO brush pulley 72 based on the engagement between the PTO drive shaft 38 and the PTO brush pulley 72. The PTO brush pulley 72 then transfers the rotational energy to downstream components of the brush drive system 70 via the brush belt B1. Particularly, the rotational energy is transferred from the PTO brush pulley 72 to the downstream pulleys in the following order: first jockey pulley 74, the second jockey pulley 76, the brush pulley 78, the tension pulley 90, and lastly the third jockey pulley 92. It should be noted that the tension of the brush belt B1 may also be adjusted based on the tension and/or biasing force applied to the tension arm 82 by the first biaser 88. Upon such application of rotational force to the brush drive system 70, the brush 40 rotates in a first rotational direction or clockwise direction; such first rotational direction applied to the brush 40 is denoted by an arrow labeled “RF1” in FIGS. 15A-15D.

With respect to the auger drive system 100, the PTO drive shaft 38 also transfers the rotational energy to the PTO auger pulley 102 based on the engagement between the PTO drive shaft 38 and the PTO auger pulley 102. The PTO brush pulley 72 then transfers the rotational energy to downstream components of the auger drive system 100 via the auger belt B2. Particularly, the rotational energy is transferred from the PTO auger pulley 102 to the downstream pulleys in the following order: first jockey pulley 104, second jockey pulley 106, auger pulley 108, and lastly the tension pulley 116. It should be noted that the tension of the auger belt B2 may also be adjusted based on the tension and/or biasing force applied to the tension arm 112 by the second biaser 114. Upon such application of rotational force to the auger drive system 100, the auger 50 (particularly the drive shaft 52, the sets of blades 56, and the set of spacers 58) rotates in a second rotational direction or counterclockwise direction that is opposite to the first rotational direction of the brush 40; such second rotational direction applied to the auger 50 is denoted by an arrow labeled “RF2” in FIGS. 15A-15D.

It should be noted that the PTO drive shaft 38 transfers the rotational energy to the brush drive system 70 and the auger drive system 100 concurrently based on the structural connections between the PTO drive shaft 38, the PTO brush pulley 72, and the PTO auger pulley 102. In other exemplary embodiments, the PTO 30 of the implement 10 may be designed such that rotational energy is transferred to the brush drive system 70 and the auger drive system 100 independently. In this instance, a first drive shaft of the PTO 30 may engage with and transfer rotational energy to the brush drive system 70, and a second drive shaft of the PTO 30 that may engage with and transfer rotational energy to the auger drive system 100 where the first drive shaft and the second drive shaft are separate and distinct components. With this configuration, the brush drive system 70 and the auger drive system 100 may be operated independently of one another in which the brush 40 and auger 50 may operate at different time intervals.

Once the brush drive system 70 and the auger drive system 100 are transferred the rotational energy from the PTO 30, the brush 40 and the auger 50 begin to rotate simultaneously. As the implement 10 traverses a ground surface (generally labeled as “G” in FIGS. 15A-15D), one or more blades of the sets of blades 56 may capture and lift one or more weeds of an unwanted vegetation (generally labeled as “BL” in FIGS. 15A-15D) from a turf or lawn area (generally referred to as “L” in FIGS. 15A-15D) as the sets of blades 56 rotate with the drive shaft 52. As best seen in FIG. 15B, at least one tooth of a plurality of teeth 56G of a blade of the first set of blades 56-1 striates a first weed “BL1” (hereinafter called “captured weed”) of the unwanted vegetation “BL” as the implement 10 traverses over the ground surface “G”. At this stage, it should be understood that the brush 40 may contact the unwanted vegetation “BL” but is free from destroying or separating blades of grass from the ground surface that make up the lawn or turf area with the set of bristles 40F in same manner as mentioned herein with respect to unwanted vegetation.

Once the sets of blades 56 capture and lift the first weed “BL1” away from the ground surface “G” as shown in FIG. 15B, the captured weed “BL1” is then lifted by the auger 50 and pushed into the set of bristles 40F of the brush 40. As best seen in FIG. 15C, the blade of the first set of blades 56-1 pushes the captured weed “BL1” into one or more bristles of the set of bristles 40F of the brush 40. Such interaction between the brush 40 and the auger 50 is possible due to the brush 40 and the auger 50 interfacing with and/or contacting one another based on the structural arrangement of the brush 40 and the auger 50 inside of the housing 20. With such interaction, the set of bristles 40F of the brush 40 is capable of passing over and between the sets of blades 56 (see FIGS. 15A-15D). At this stage, the set of bristles 40F also striate and slice into the captured weed “BL1” as the captured weed “BL1” is pressed into the brush 40; such cuts or striations that are made in the captured weed “BL1” are denoted by lines labeled “S” in FIGS. 15C-15D. Such cuts or striations made into the captured weed “BL1” by the brush 40 help destroy and dissociate the captured weed “BL1” into multiple pieces as the captured weed “BL1” continues to be rotated by the auger 50 and further pressed into the brush 40. It should be noted that such destruction of the captured weed “BL1” is also performed on the remaining weeds “BL” of the unwanted vegetation “BL” as the implement 10 traverses over the ground surface “G”.

Such damage and destruction of unwanted vegetation performed by the brush 40 and the auger 50 is considered advantageous at least because the damaged vegetation will be stunted and/or incapable of producing new, healthy leaves. By stunting the capability of producing new, healthy leaves, such vegetation will heavily rely upon carbohydrate reserves stored in their respective root systems and will eventually die once such reserves are depleted. Since the implement 10 only damages and stunts the growth of unwanted vegetation, the lawn or turf area is unaffected by operation performed by the brush 40 and the auger 50 due to the slenderness and resiliency of the blades of grass that make up the lawn/turf area.

In operation, the roller kit 130 maintains and holds the implement 10 in a direction at which the vehicle 1 and the implement 10 are traveling. As best seen in FIGS. 15A-15D, the roller kit 130 rotates in a third rotational or clockwise direction as the vehicle 1 and the implement 10 are traveling in a forward or first direction to maintain and hold the implement 10; such third rotational direction applied to the roller kit 130 is denoted by an arrow labeled “RF3” in FIGS. 15A-15D. While not illustrated herein, the roller kit 130 may also rotate in an opposite or counter-clockwise direction when the vehicle 1 and the implement 10 are traveling in a reverse or second direction. Additionally, the skids 16 provided with implement 10 also prevent the brush 40 and the auger 50 from driving into and scalping the lawn and/or turf area as the vehicle 1 and implement 10 traverse along said lawn and/or turf area.

Once the implement 10 has traversed over the lawn or turf area, the weed or unwanted vegetation is damaged and/or destroyed due to the interactions with the brush 40 and the auger assembly 50 (see weeds labeled BL′ in FIG. 15E). As best seen in FIG. 15E, the weeds BL′ have been ripped, torn, shredded, and, ultimately, damaged upon the brush 40 and the auger 50 interacting with the weeds BL'. At this stage, such damage and destruction that occurred to the weeds BL′ should stunt and/or prevent future growth of such weeds BL'. In this illustration, the lawn or turf area “L” has also been mowed and/or cut subsequent to the weeds BL′ being damaged and destroyed by the implement 10.

It should be noted that as the implement 10 traverses the ground surface “G”, the lawn “L” planted in the ground surface “G” is unharmed and/or nonaffected due to the structural configuration of the brush 40 and the auger 50. As such, the brush 40 and the auger 50 simply rotate through the lawn “L” and between blades of grass without uprooting or removing grass from the surrounding area (see FIG. 15E). In addition, the configuration of each blade of the sets of blades 56 is also considered advantageous at least because the plurality of teeth 56G may capture and damage unwanted vegetation at lower heights measured relative to a ground surface (such as ground surface “G”) or measured relative to a lawn height. In one instance, the plurality of teeth 56G of one or more blades of the sets of blades 56 may capture and striate unwanted vegetation that is above a lawn height. In another instance, the plurality of teeth 56G of one or more blades of the sets of blades 56 may capture and striate unwanted vegetation that is even and/or parallel with a lawn height. In another instance, the plurality of teeth 56G of one or more blades of the sets of blades 56 may capture and striate unwanted vegetation that is below a lawn height.

In the present disclosure, the unwanted vegetation discussed and illustrated herein is a broadleaf weed that is common to growing in lawns or other turf environments. Examples of broadleaf weeds that may be damaged and destroyed in lawn or turf environments include, but are not limited to, chickweed, clover, dandelion, wild geranium, ivy, milkweed, and other similar types of broadleaf weeds that grow in lawns or other turf environments. It should be understood that implement 10 may damage and/or damage other common unwanted vegetation from lawns or other turf environments without the use of harmful chemicals and/or pesticides. In one exemplary embodiment, implement 10 may damage and/or separate crabgrass from lawns or other turf environments without the use of harmful chemicals and/or pesticides.

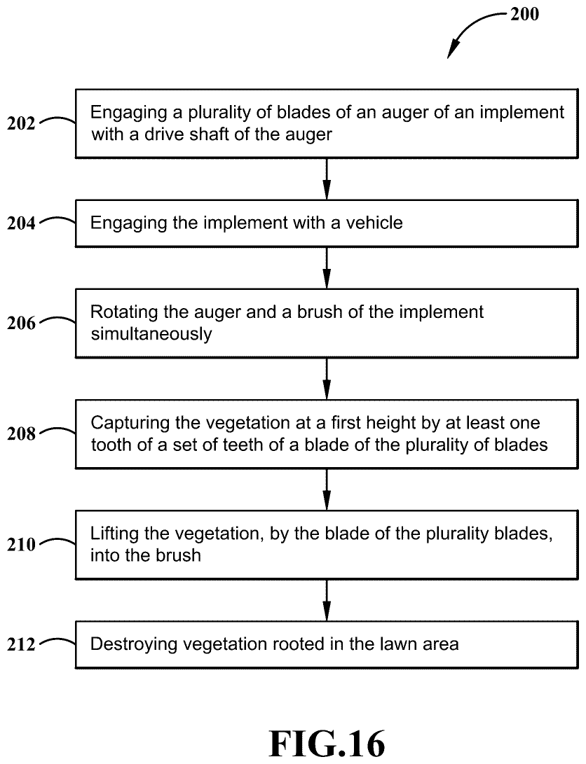

FIG. 16 illustrates a method 200 of damaging unwanted vegetation rooted in a lawn area. An initial step 202 of method 200 includes engaging a plurality of blades of an auger of an implement with a drive shaft of the auger. Another step 204 of method 200 includes engaging the implement with a vehicle. Another step 206 of method 200 includes rotating the auger and a brush of the implement simultaneously. Another step 208 of method 200 includes capturing the unwanted vegetation at a first height by at least one tooth of a set of teeth of a blade of the plurality of blades. Another step 210 of method 200 includes lifting the unwanted vegetation, by the blade of the plurality blades, into the brush. Another step 212 of method 200 includes damaging the unwanted vegetation rooted in the lawn area.

In other exemplary embodiments, method 200 may include additional and/or optional steps in damaging the unwanted vegetation rooted in a lawn area. In one exemplary embodiment, method 200 may further include that the step of engaging the plurality of blades with the drive shaft further includes that each blade of the plurality of blades is individually engaged with the drive shaft. In another exemplary embodiment, method 200 may further include that that the step of rotating the auger and the brush of the implement simultaneously further comprises: rotating the brush about a first drive axis; and rotating the auger about a second drive axis; wherein the second drive axis is positioned behind the first drive axis. In another exemplary embodiment, method 200 may further include steps of capturing the unwanted vegetation at a second height by at least one tooth of a second set of teeth of a second blade of the plurality of blades, wherein the second height is greater than the first height; and lifting the unwanted vegetation, by the second blade of the plurality blades, into the brush. In another exemplary embodiment, method 200 may further include steps of capturing the unwanted vegetation at a third height by at least one tooth of a third set of teeth of a third blade of the plurality of blades, wherein the third height is greater than the first height and the second height; and lifting the unwanted vegetation, by the third blade of the plurality blades, into the brush. In another exemplary embodiment, method 200 may further include that the step of engaging the plurality of blades with the drive shaft further comprises: inserting a keyed portion of each blade of the plurality of blades into a keyway defined inside of the drive shaft.

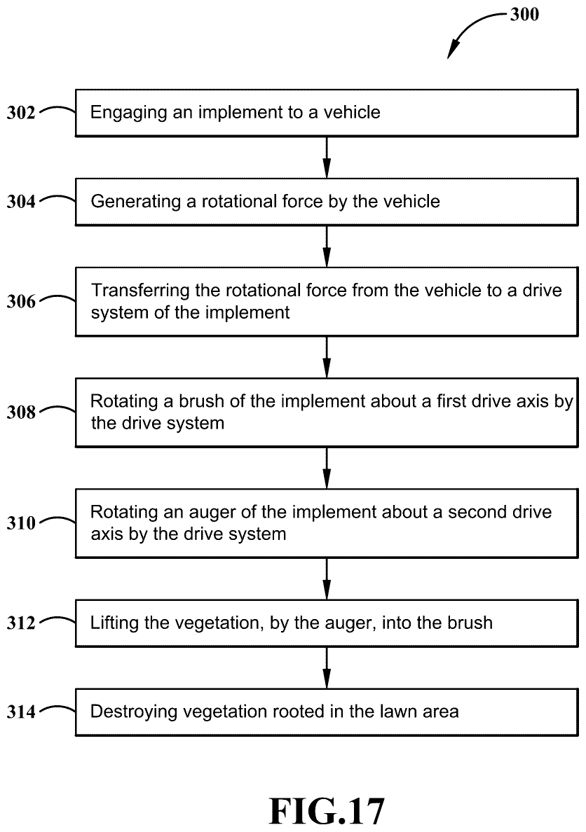

FIG. 17 illustrates another method 300 of damaging unwanted vegetation rooted in a lawn area. An initial step 302 of method 300 includes engaging an implement to a vehicle. Another step 304 of method 300 includes generating a rotational force by the vehicle. Another step 306 of method 300 includes transferring the rotational force from the vehicle to a drive system of the implement. Another step 308 of method 300 includes rotating a brush of the implement about a first drive axis by the drive system. Another step 310 of method 300 includes rotating an auger of the implement about a second drive axis by the drive system, wherein the second rotational axis is positioned behind the first drive axis. Another step 312 of method 300 includes lifting the unwanted vegetation, by the auger, into the brush. Another step 314 of method 300 includes damaging the unwanted vegetation rooted in the lawn area.

In other exemplary embodiments, method 300 may include additional and/or optional steps in damaging the unwanted vegetation rooted in a lawn area. In one exemplary embodiment, method 300 may further include that the step of rotating the brush about the first drive axis further includes: rotating the brush at a first rotational speed; and wherein the step of rotating the auger about the second drive axis further includes: rotating the auger at a second rotational speed that is different than the first rotational speed. In another exemplary embodiment, method 300 may further include that the second rotational speed of the auger is three times greater than the first rotational speed of the brush. In another exemplary embodiment, method 300 may further include that the first rotational speed generated on the brush by the drive system is approximately 1,600 revolutions per minute; and wherein the second rotational speed generated on the auger by the drive system is approximately 4,800 revolutions per minute. In another exemplary embodiment, method 300 may further include that the step of transferring the rotational force from the vehicle to the drive system further comprises: transferring the rotational force from the vehicle to a power take-off (PTO) system of the implement; transferring the rotational force from the PTO system to a brush drive system of the implement; and transferring the rotational force from the PTO system to an auger drive system of the implement. In another exemplary embodiment, method 300 may further include that the steps of rotating the brush and rotating the auger further comprises: rotating the brush in a first rotational direction about the first drive axis; and rotating the auger in a second rotational direction about the second drive axis; wherein the first rotational direction and the second rotational direction are directed at one another. In another exemplary embodiment, method 300 may further include that the brush drive system and the auger drive system are each belt driven systems.

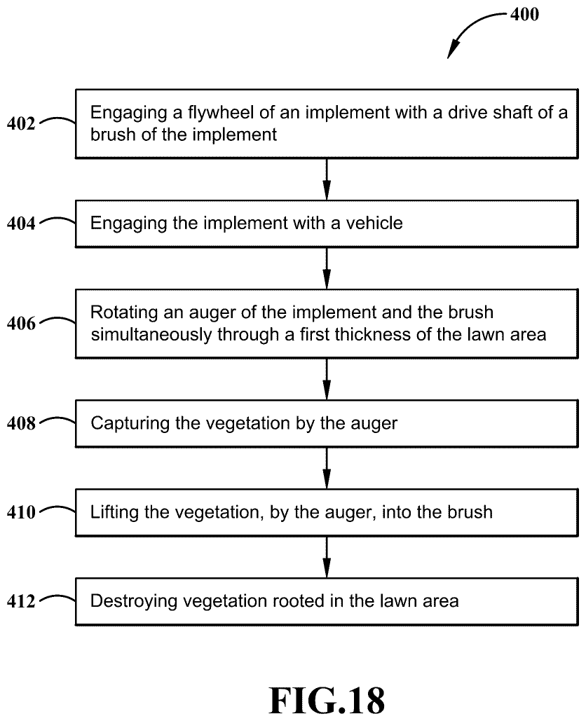

FIG. 18 illustrates another method 400 of damaging unwanted vegetation rooted in a lawn area. An initial step 402 of method 400 includes engaging a flywheel of an implement with a drive shaft of a brush of the implement. Another step 404 of method 400 includes engaging the implement with a vehicle. Another step 406 of method 400 includes rotating an auger of the implement and the brush simultaneously through a first thickness of the lawn area; wherein the brush is rotated at a first rotational speed. Another step 408 of method 400 includes capturing the unwanted vegetation by the auger. Another step 410 of method 400 includes lifting the unwanted vegetation, by the auger, into the brush. Another step 412 of method 400 includes damaging the unwanted vegetation rooted in the lawn area.

In other exemplary embodiments, method 400 may include additional and/or optional steps in damaging the unwanted vegetation rooted in a lawn area. In one exemplary embodiment, method 400 may further include steps of: rotating the auger of the implement and the brush simultaneously through a second thickness of the lawn area that is greater than first thickness of the lawn area; and maintaining the first rotational speed of the brush by the flywheel. In another exemplary embodiment, method 400 may further include that the step of maintaining the first rotational speed of the brush by the flywheel further includes that the brush is maintained at approximately 1,600 revolutions per minute when rotating through the second thickness of the lawn area. In another exemplary embodiment, method 400 may further include that the step of engaging the flywheel with the drive shaft of the brush further comprises: engaging a portion of the drive shaft inside of an inner hub of the flywheel; and locking the inner hub and the drive shaft with a key. In another exemplary embodiment, method 400 may further include steps of: inserting the key through a first keyway defined in the inner hub of the flywheel; and inserting the key through a second keyway defined in the drive shaft. In another exemplary embodiment, method 400 may further include steps of positioning the brush and the auger inside of a cavity defined by a housing of the implement; and positioning the flywheel outside of the cavity defined by the housing.

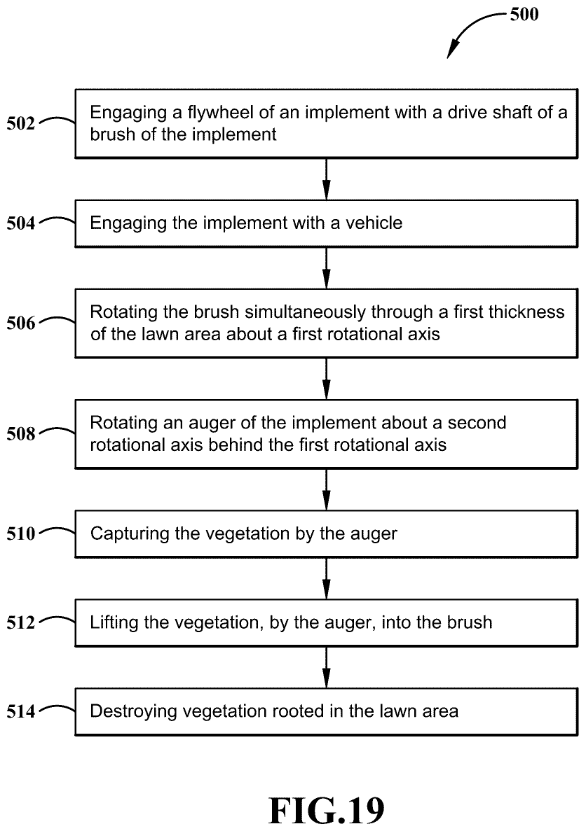

FIG. 19 illustrates another method 500 of damaging the unwanted vegetation rooted in a lawn area. An initial step 502 of method 500 includes engaging a flywheel of an implement with a drive shaft of a brush of the implement. Another step 504 of method 500 includes engaging the implement with a vehicle. Another step 506 of method 500 includes rotating the brush simultaneously through a first thickness of the lawn area about a first rotational axis; wherein the brush is rotated at a first rotational speed. Another step 508 of method 500 includes rotating an auger of the implement about a second rotational axis behind the first rotational axis. Another step 510 of method 500 includes capturing the unwanted vegetation by the auger. Another step 512 of method 500 includes lifting the unwanted vegetation, by the auger, into the brush. Another step 514 of method 500 includes damaging the unwanted vegetation rooted in the lawn area.

In other exemplary embodiments, method 500 may include additional and/or optional steps in damaging the unwanted vegetation rooted in a lawn area. In one exemplary embodiment, method 500 may further include steps of rotating the auger of the implement and the brush simultaneously through a second thickness of the lawn area that is greater than first thickness of the lawn area; and maintaining the first rotational speed of the brush by the flywheel. In another exemplary embodiment, method 500 may further include that the step of maintaining the first rotational speed of the brush by the flywheel further includes that the brush is maintained at approximately 1,600 revolutions per minute when rotating through the second thickness of the lawn area. In another exemplary embodiment, method 500 may further include that the step of engaging the flywheel with the drive shaft of the brush further comprises: engaging a portion of the drive shaft inside of an inner hub of the flywheel; and locking the inner hub and the drive shaft with a key. In another exemplary embodiment, method 500 may further include steps of inserting the key through a first keyway defined in the inner hub of the flywheel; and inserting the key through a second keyway defined in the drive shaft. In another exemplary embodiment, method 500 may further include steps of positioning the brush and the auger inside of a cavity defined by a housing of the implement; and positioning the flywheel outside of the cavity defined by the housing.

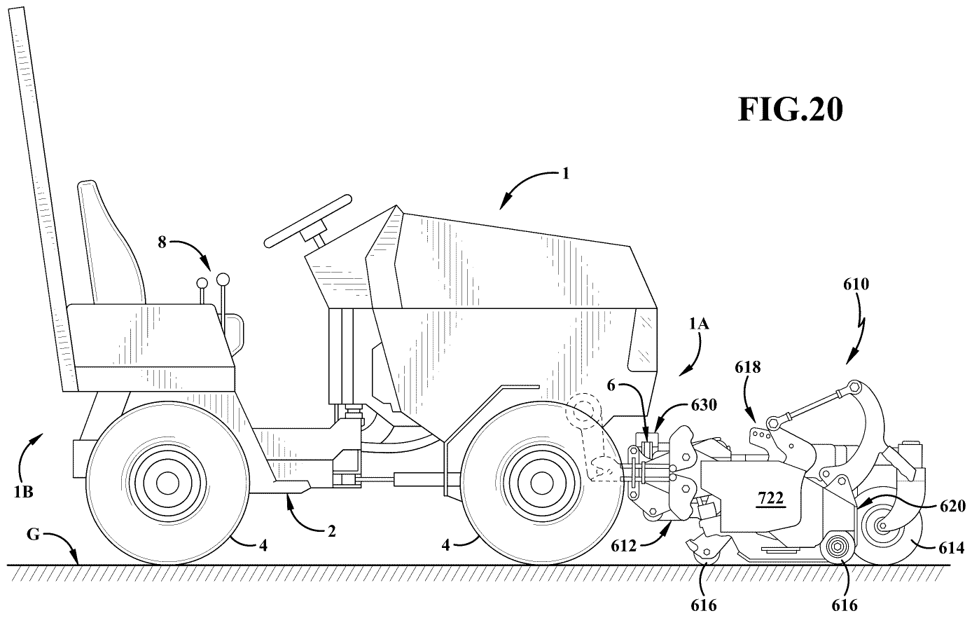

FIGS. 20-27 illustrate another implement 610 that is equipped to vehicle 1. It should be understood that implement 10 may include similar systems, assemblies, and components of implement 10 that are discussed above and illustrated in FIGS. 1-15; however, implement 610 does include different systems, assemblies, or components from the implement 10 that are discussed in greater detail below.

Referring to FIG. 20, an implement 610 is equipped to the vehicle 1 using an attachment frame assembly 612. For simplicity and clarity in the disclosure, implement 610 will be described generally as a broadleaf weed or unwanted vegetation control machine; however, the attachment frame assembly 612 may be utilized with any suitable implement as will become apparent herein. In one exemplary embodiment, attachment frame assembly 612 may be attachment frame assembly disclosed in U.S. Pat. No. 12,178,154 with an issue date of Dec. 31, 2024.

Implement 610 may include at least one ground-engaging member 614, which may be a wheel, a skid, a ski, or other suitable ground-engaging devices mentioned herein. Collectively, ground-engaging members 614 may define the operational height of implement 10 as discussed further herein. Where implement 610 is a broadleaf weed control machine, ground-engaging members may be adjusted by adjustment mechanisms (which are discussed below) to set the height of the machine, such as the height at which vegetation will be captured and damaged in the lawn or turf area by a brush assembly and an auger assembly of the broadleaf weed control machine; such components and elements of the brush assembly and auger assembly of the broadleaf weed control machine are discussed in greater detail below. Implement 10 also include skids or anti-scalp wheels 616 that are fixed and spaced apart from the wheels 614. In operation, anti-scalp wheels 616 are configured to sit below a brush and/or auger of the implement 610 so that such brush and auger are free from driving into and/or scalping the lawn or turf; such description of the brush and auger of implement 610 are described in greater detail below. When implement 160 is not being used or operated, anti-scalp wheels 616 may provide support to the implement 610. Implement 610 may further include one or more frame components generally indicated at 618 and may further include one or more adjustment mechanisms that are previously discussed herein.

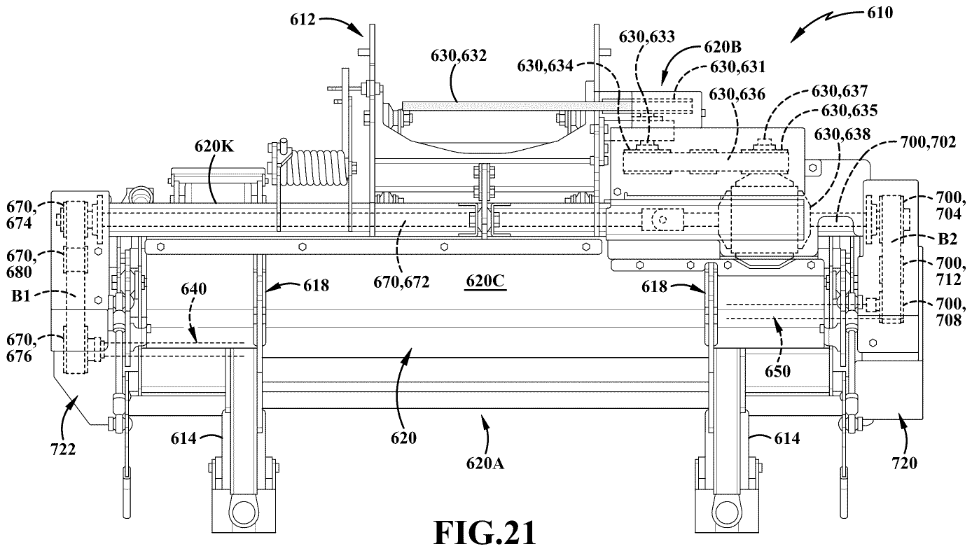

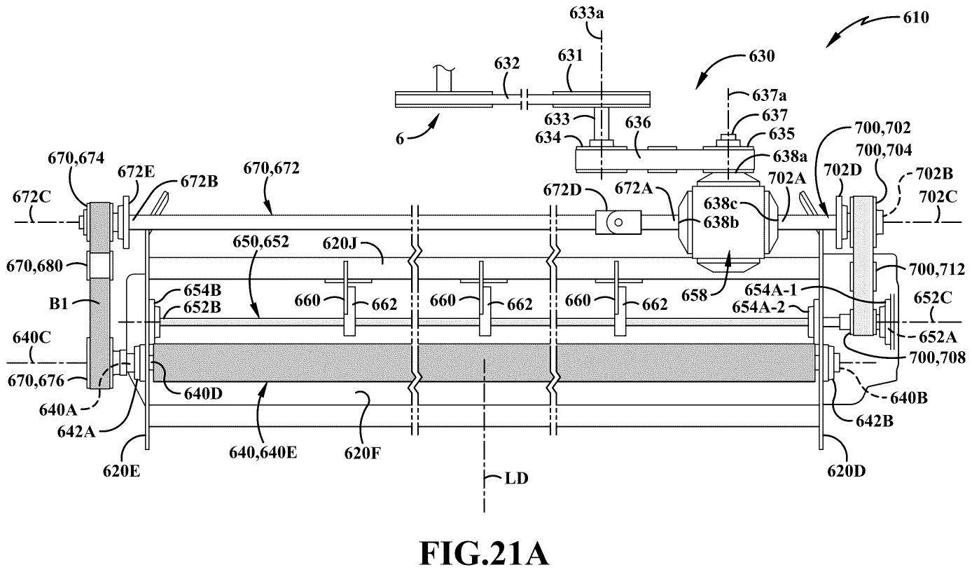

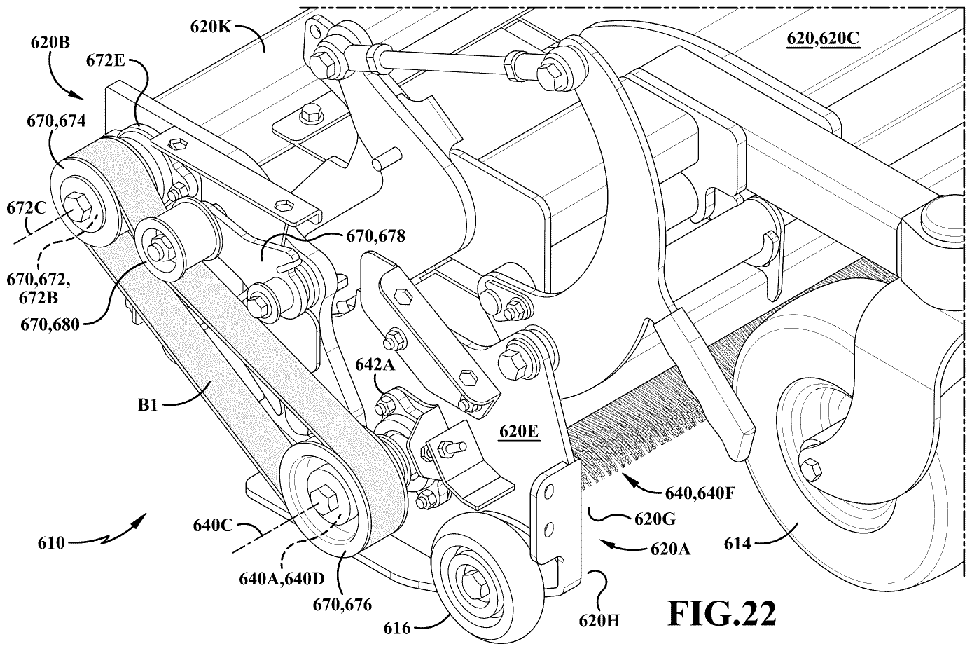

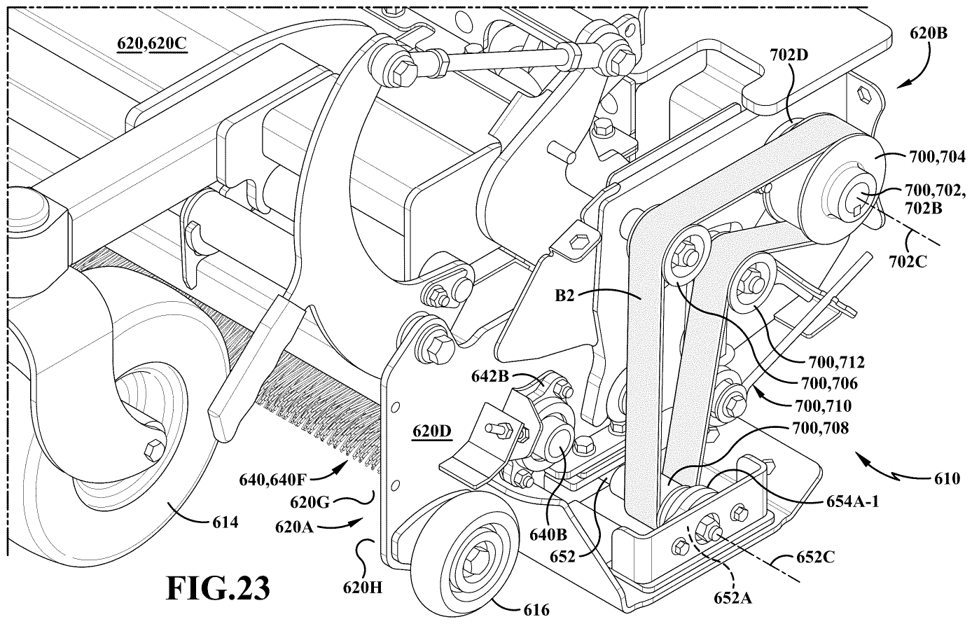

Implement 610 may further include a housing 620 which may house one or more operational components of the implement 610. As best seen in FIG. 21, the housing 620 includes a front end 620A, a rear end 620B opposite to the front end 620A, a top wall 620C positioned between the front end 620A and the rear end 620B, and a pair of side walls 620D, 620E that extends downwardly from top wall 620C wherein a first side wall 620D and a second side wall 620E is spaced apart from one another. Housing 620 also defines a cavity 620F by the top wall 620C and the pair of side walls 620D, 620E, collectively (see FIG. 22). The housing 620 also defines a front opening 620G by the top wall 620C and the pair of side walls 620D, 620E, collectively, and provides access into the cavity 620F at the front end 620A (see FIGS. 22-23). The housing 620 also defines a bottom opening 620H by the pair of side walls 620D, 620E and provides access into the cavity 620F at a position vertically below the front opening 620G (see FIGS. 22-23).

Housing 620 also includes a rear support bar 620J that is housed inside of the cavity 620F. As best seen in FIG. 21A, the rear support bar 620J extends between and engages with the first side wall 620D and the second side wall 620E. In the present disclosure, the rear support bar 620J is also positioned towards the rear end 620B of the housing 620 while also being positioned inside of the cavity 620F. The rear support bar 620J is also positioned away from the front opening 620G. Such use and purpose of the rear support bar 620J with an auger assembly of the implement 610 is discussed in greater detail below.

Housing 620 also includes a rear support tube 620K that is housed inside of the cavity 620F. As best seen in FIG. 21, the rear support tube 620K extends between and engages with the first side wall 620D and the second side wall 620E. In the present disclosure, the rear support tube 620K is positioned at the rear end 620B of the housing 620 while also being positioned behind the rear support bar 620J. The rear support tube 620K is also positioned away from the front opening 620G. As discussed in greater detail below, the rear support tube 620K is configured to house drive axles of brush and auger drive systems of implement 610 to protect such drive axles from debris that is cut and thrown inside of the cavity 620F of housing 620.

Implement 610 also includes a power system or power take-off (PTO) generally referred to as 630. As best seen in FIG. 21A, PTO 630 includes a first PTO pulley 631 that operably engages with a PTO of the vehicle (such as PTO 6 discussed above) via a first PTO belt 632. Such engagement between the PTO 6 of the vehicle 1 and the first PTO pulley 631 by the first PTO belt 632 allows the vehicle to transfer rotational energy to the implement 610 to rotate a brush assembly and an auger assembly of the implement 610, which are discussed in greater detail below.

Still referring to FIG. 21A, PTO 630 also includes a first PTO drive shaft 633 that rotatably engages the first PTO pulley 631 and a second PTO pulley 634 with one another. It should be noted that first PTO drive shaft 633 defines a rotational or drive axis 633A along the length of said first PTO drive shaft 633 that is parallel to a longitudinal direction (denoted as “LD” in FIG. 21A) of implement 610. PTO 630 also includes a third PTO pulley 635 that rotatably engages with the second PTO pulley 634 by a second PTO belt 636. Such engagement between the second PTO pulley 634 and the third PTO pulley 635 by the second PTO belt 636 allows implement 610 to transfer rotational energy to rotate the brush and auger assemblies of the implement 610, which are discussed in greater detail below. PTO 630 also includes a second PTO drive shaft 637 that rotatably engages the third PTO pulley 635 and a gearbox 638 of PTO 630 with one another. It should be noted that second PTO drive shaft 637 also defines a rotational or drive axis 637A along the length of said second PTO drive shaft 637 that is parallel to the longitudinal direction of implement 610.

Still referring to FIG. 21A, PTO 630 also includes a gearbox 638 that operably engages with the third PTO pulley 635 by the second PTO drive shaft 637. As best seen in FIG. 21A, the third PTO pulley 635 and the second PTO drive shaft 637 are upstream of the gearbox 638 so that the third PTO pulley 635 (as well as the remaining PTO pulleys 631, 634, PTO belts 632, 636, and PTO drive shaft 633) may transfer rotational energy to the gearbox 638 that is received from and generated by the vehicle 1. In this embodiment, the gearbox 638 directly engages with second PTO drive shaft 637 at a first end or input 638a of gearbox 638. Still referring to FIG. 21A, gearbox 638 also includes a first output 638b that is configured to rotatably engage with a drive axle of a first or brush drive system of implement 610, which is discussed in greater detail below. Gearbox 638 also includes a second output 638c that is configured to rotatably engage with a drive axle of a second or auger drive system of implement 610, which is discussed in greater detail below. In operation, gearbox 638 is configured transfer rotational energy to two drive axles of two different drive systems of implement 610 at two opposing locations on implement 610. With such configuration, the two drive systems of implement 610 are configured to operate at two opposing location on the implement 610 to spin a brush and an auger of implement 610 inside of housing 620.

Implement 610 also includes a brush 640 that rotatably engages with the housing 620 and the PTO 630. As best seen in FIG. 21A, the brush 640 includes a first end 640A positioned proximate to the second side wall 620E, a second end 640B positioned proximate to the first side wall 620D and opposite to the first end 640A, and a longitudinal axis 640C defined therebetween. As best seen in FIGS. 22 and 23, the brush 640 is also substantially housed inside of the cavity 620F between the front opening 620G of the housing 260 and the bottom opening 620H of the housing 620.

Still referring to brush 640, brush 640 includes a drive shaft 640D. As best seen in FIG. 21A, the drive shaft 640D extends longitudinally between the first end 640A of the brush 640 and the second end 640B of the brush 640. Still referring to FIG. 21A, the brush 640 also includes a barrel or rotor 640E extends between the first end 640A and the second end 640B and is disposed circumferentially about the drive shaft 640D. The brush 640 also includes a set of bristles 640F that extends radially outward from the barrel 640E at a length away from the barrel 640E (see FIGS. 22 and 23). Similar to the set of bristles 40F of brush 40 of implement 10, the set of bristles 640F is also positioned in a helical arrangement about the barrel 640E between the first end 640A and the second end 640B of the brush 640. Such helical arrangement is considered advantageous at least because at least one or more bristles of the set of bristles 640F always contact and/or interacts with one or more unwanted vegetation or weeds when operating the implement 610 on a lawn or turf area.

While not illustrated herein, brush 640 may also defines a pair of keyways (similar to keyways 40G1, 40G2 of implement 10) in one or more portions of the drive shaft 640D. Such use of these keyways or similar connection mechanism may be used to lock or secure the brush 640 in place while allows the brush 640 to rotate for removing unwanted vegetation.

Implement 610 may also include a pair of pillow bearing blocks 642A, 642B (see FIG. 21A) that rotatably engages with the brush 440 and is attached to the housing 420 similar to the pair of pillow bearing blocks 42A, 42B of implement 10 mentioned above. Such use of the first pair of pillow bearing blocks 642A, 642B provides axial support to the drive shaft 640D as the brush 640 rotates about the longitudinal axis 640C.

Implement 610 also includes an auger assembly (herein after “auger”) that is generally referred to as 650. In the present disclosure, certain components of auger 650, which are mentioned in further detail below, rotatably engages with the housing 620 and is substantially housed inside of the cavity 620F behind the brush 640.

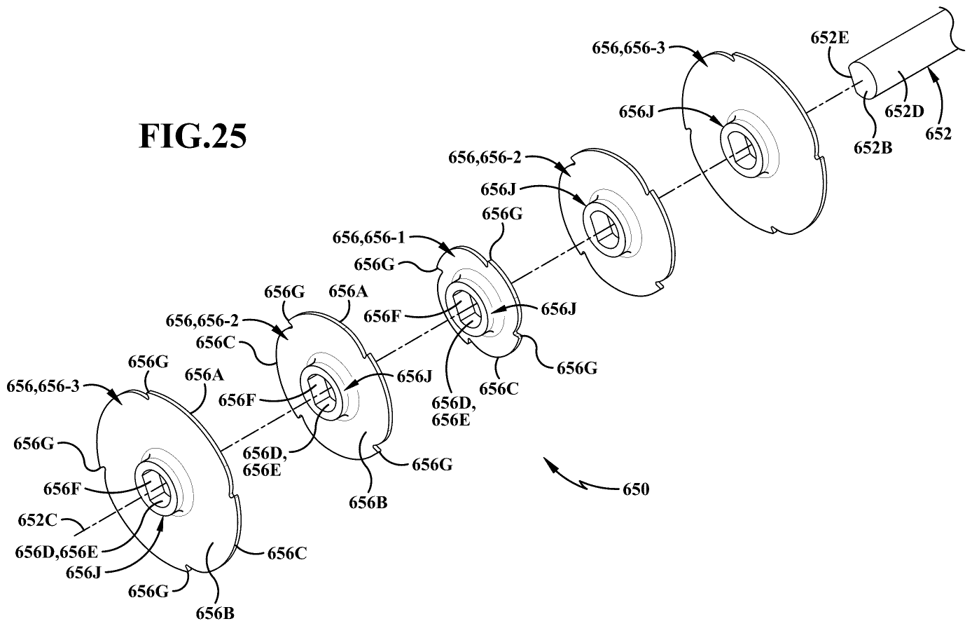

As best seen in FIG. 21A, the auger 650 includes a drive shaft 652 that has a first end 652A, a second end 652B opposite to the first end 652A, and a longitudinal axis 652C defined therebetween. Referring to FIG. 25, the drive shaft 652 also includes an outer surface 652D that extends between the first end 652A and the second end 652B. Still referring to FIG. 25, the drive shaft 652 also defines a keyway 652E that extends along the entire length of the drive shaft 652 between the first end 652A and the second end 652B. In the present disclosure, the keyway 652E is shown as a flat or planar surface making the outer surface 652D have a D-shaped cross-sectional shape when viewed from a side elevation (see FIG. 25). It should be noted that other suitable shapes may be used to defined keyway 652E as well as other keyways mentioned herein may be defined in drive shaft 652.

The drive shaft 652 also operably engages with a set of pillow bearing blocks 654A-1, 654A-2, 654B (see FIGS. 22 and 23) that is attached to the housing 620 similar to the pairs of pillow bearing blocks 54A, 54B previously discussed in implement 10. Such use of the pairs of pillow bearing blocks 654A-1, 654A-2, 654B provides axial support to the drive shaft 652 as the drive shaft 652, along with additional components of the auger 650 engaged with the drive shaft 652, rotates about the longitudinal axis 652C; such operation of the auger 650 is discussed in greater detail below.

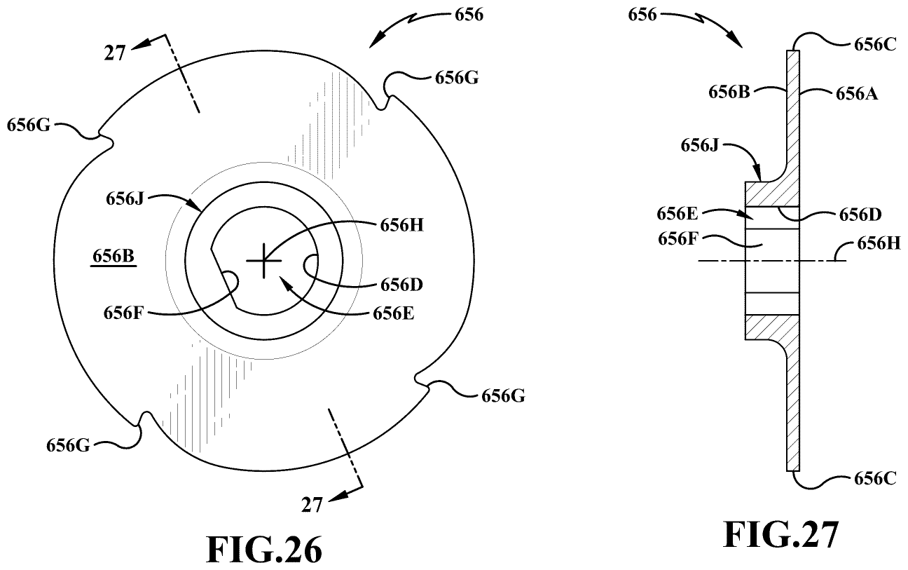

Auger 650 also includes at least one sets of blades 656. As best seen in FIGS. 26-27, each blade of the sets of blades 656 includes a first side 656A, a second side 656B opposite to the first side 656A, an peripheral wall 656C that extends between the first side 656A and the second side 656B, and an inner surface 656D that extends between the first side 656A and the second side 656B and is internal to and remote from the peripheral wall 656C. Each blade of the sets of blades 656 also defines an passageway 656E, by the inner surface 656D, that extends entirely through the blade 656 between the first side 656A and the second side 656B (see FIG. 27); the first side 656A and the second side 656B are in communication with one another at the passageway 656E. Each blade of the sets of blades 656 also includes a keyed portion 656F that extends outwardly from the inner surface 656D and into the passageway 656E (see FIGS. 26-27). Upon assembly, the keyed portion 656F of each blade of the sets of blades 656 are sized and configured to mechanically engage with the drive shaft 652 at the keyway 652E so that the sets of blades 656 are secured to the drive shaft 652.

Each blade of the sets of blades 656 also defines a plurality of teeth 656G. As best seen in FIG. 26, each tooth of the plurality of teeth 656G is defined along the peripheral wall 656C and is positioned between the first side 656A and the second side 656B. Such structural configuration and orientation of the plurality of teeth 656G included 57 with each blade of the plurality of blades 656 are substantially similar to the structural configuration and orientation of the plurality of teeth 56G included with each blade of the plurality of blades 56 of implement 10.

Each blade of the sets of blades 656 also defines a central axis 656H. As best seen in FIG. 26, the central axis 656H extends between the first side 656A and the second side 656B. Upon assembly of the drive shaft 652 and the sets of blades 656, the central axis 656H of each blade of the sets of blades 656 is coaxial with the longitudinal axis 652C of the drive shaft 652 such that the drive shaft 652 and the sets of blades 656 share a common rotational axis.

Similar to the sets of blades 56 of implement 10, auger 650 may include one or more sets of blades 656 that define different sizes, shapes, or configurations needed to capture and striate weeds or unwanted vegetation into the brush 640 when operating implement 610. In this embodiment, the auger 650 may include a first set of blades 656-1 that defines a first radius measured from a central axis of each blade to the peripheral wall 656C, a second set of blades 656-2 that defines a second radius measured from a central axis of each blade to the peripheral wall 656C, and a third set of blades 656-3 that defines a third radius measured from a central axis each blade to the peripheral wall 656C. In this instance, the third radius of each blade of the third set of blades 656-3 is greater than the second radius of each blade of the second set of blades 656-2 and the first radius of each blade of the first set of blades 656-1. In this same instance, the second radius of each blade of the second sets of blades 656-2 is also greater than the first radius of each blade of the first set of blades 656-1.

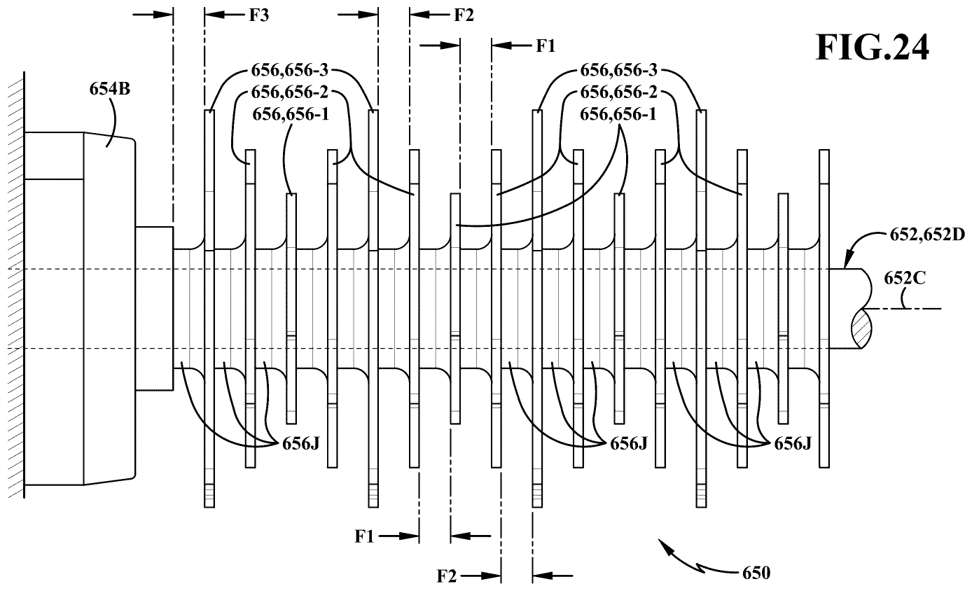

Such radius variance between the first set of blades 656-1, second set of blades 656-2, and third set of blades 656-3 is considered advantageous at least because such variance may increase the chances of capturing and destroying weeds and other similar unwanted vegetation of different sizes, shapes, and configurations from a ground surface when the vehicle and the implement 610 traverse over the ground surface. As illustrated herein, the sets of blades 656 are arranged in a staggered or stairstep configuration (see FIG. 24) to increase the chances of capturing and destroying weeds and other similar unwanted vegetation of different sizes, shapes, configurations, and heights or elevation from a ground surface when the vehicle and the implement 610 traverse over the ground surface; such staggered and/or stairstep arrangement is similar to the staggered and/or stairstep arrangement of auger 50 of implement 10 mentioned above. In this arrangement, and as best seen in FIG. 24, a blade of the third set of blades 656-3 is the initial blade of the stairstep arrangement followed by a blade of the second set of blades 656-2, a blade of the third set of blades 656-3, and another blade of the second set of blades 656-2. This four blade stairstep arrangement is repeated along the entire length of the drive shaft 652 for assembling auger 650; such arrangement is also applied to the auger 50 of implement 10 mentioned above.

In this embodiment, however, each blade of the set of blades 656 includes a spacer or extension 656J that is integrally formed with each blade 656. As best seen in FIG. 27, the spacer 656J extends outwardly from the second side 656B of blade 656. In this embodiment, the spacer 656J also defines the inner surface 656D, the passageway 656E, and the keyed portion 656F mentioned above (see FIG. 27); as such, the inner surface 656D, the passageway 656E, and the keyed portion 656F are continuous inside of the spacer 656J. Similar to spacers 58 mentioned above, each spacer 656J operably engages with the drive shaft 652 to space adjacent blades of the plurality of blades 656 from one another at predetermined distances.

Upon assembly of the auger 650, the keyed portion 656F of each blade 656 is sized and configured to engage with the drive shaft 652 at the keyway 652E each blade 656 is secured to the drive shaft 652. Upon assembly, the spacer 656J of each blade 656 directly abuts the first side 656A of an adjacent blade 656 in which such blades 656 are spaced apart from one another at a predetermined distance. Such spaced configuration of the sets of blades 656 may improve the capability of each blade of the sets of blades 656 to capture and push one or more weeds or similar unwanted vegetation from a ground surface into the brush 640 when operating implement 610 over a lawn or turf area.

Such integration of the spacer 656J into each blade 656 to provide a unitary, monolithic unit is considered advantageous at least because this configuration now provides greater surface for wear along both components. Such configuration may now reduce the number of times operators or users of implement 610 may need to repair or service the auger 650 for replacing one or more blades 656. Additionally, such integration of the blade 656 and the spacer 656J into a unitary, monolithic unit is considered advantageous because the number of components need to construct the auger 650 has reduced. As such, this configuration may now reduce the overall labor time in repairing or servicing the auger 650 when replacing one or more blades 656.

Upon assembly of the drive shaft 652, the sets of blades 656-1, 656-2, 656-3, including the integrated spacers 656J, may also be laterally spaced apart from one another due to the lengths of each spacer 656J. As best seen in FIG. 24, a blade of the first set of blades 656-1 and an adjacent blade of the second set of blades 656-2 define a first lateral distance F1 measured between one another. Similarly, and as best seen in FIG. 24, another blade of the second set of blades 656-2 and an adjacent blade of the third set of blades 656-3 define a second lateral distance F2 measured between one another. Still referring to FIG. 24, the outermost blade of the third set of blades 656-3 and a pillow bearing block of the second pair of pillow bearing blocks 654B also define a third lateral distance F3 measured between one another. In the present disclosure, the first lateral distance F1, the second lateral distance F2, and the third lateral distance F3 are equal to one another due to each spacer 656J having a uniform length. In other exemplary embodiments, the first lateral distance F1, the second lateral distance F2, and the third lateral distance F3 mentioned herein may be any suitable distance based on various considerations, including overall length of each spacer 656J, the overall thickness of each blade of a set of blades, and other various considerations.

In FIG. 21A, auger 650 also includes a set of support brackets 660 similar to the set of support brackets 60 of auger 50 of implement 10. With such inclusion of the set of support brackets 660, the drive shaft 652 of the auger 650 is suspended and/or cantilevered at one or more location between the first end 652A and the second end 652B to provide additional strength and rigidity to the drive shaft 652 as the drive shaft 652 rotates and interferes with weeds and other similar unwanted vegetation. Auger 650 also include bearings 662 that are engaged with the set of support brackets 660 similar to bearings 62 being engaged with the set of support brackets 60 of implement 10. With this configuration, the drive shaft 652 of the auger 650 is also axially supported by the bearings 662 between the first end 652A and the second end 652B when the drive shaft 652 is rotating at a specific speed or rate of rotation.

Implement 10 also includes a first or brush drive system 670 that operably engages with the PTO 630 of implement 610. As best seen in FIG. 21A, the brush drive system 670 includes a first drive axle or brush drive axle 672 that operably engages with the first output 638B of gearbox 638. Particularly, the brush drive axle 672 includes a first or input end 672A that is operative with the first output 638B of gearbox 638, a second or output end 672B that is operative with a PTO brush pulley of brush drive system 670, and a longitudinal or rotational axis 672C extending between the input end 672A and the output end 672B. Brush drive axle 672 also includes a yoke 672D that is positioned between the input end 672A and the output end 672B. The brush drive axle 672 is also rotatably supported with the housing 620 at the second side 630E by a pillow block bearing 672E.

Still referring to brush drive system 670, brush drive system 670 also includes a PTO brush pulley 674 and a brush pulley 676. As best seen in FIGS. 21A and 22, the PTO brush pulley 674 operably connects with the output end 672B of brush drive axle 672, and the brush pulley 676 operably connects with the drive shaft 640D of the brush 640 at the first end 640A and is downstream of the PTO brush pulley 674. In the brush drive system 670, a first or brush belt B1 operably engages with the PTO brush pulley 674 and the brush pulley 676 to transfer rotational energy from the brush drive axle 672 to the drive shaft 640d of brush 640.

In FIG. 22, the brush drive system 670 also includes a tensioner 678 that has a tension pulley 680. In this embodiment, the tension pulley 680 engages with a tension arm of tensioner 678 similar to tensioner 80 of brush drive system 70 of implement 10 in which the tension arm of the tensioner 678 applies a biasing force on the first belt B1 based on the biasing characteristics of a biaser of the tensioner 678. It should be noted that tensioner 678 and the tension pulley 680 are positioned intermediate to PTO brush pulley 674 and the brush pulley 676 (see FIG. 22). With this configuration, tension pulley 680 is configured to apply variable tension along brush belt B1 of the brush drive system 670 as the brush belt B1 circulates between the PTO brush pulley 674 and the brush pulley 676.

It should be understood that the pulleys 674, 676, 680 of the brush drive system 670 may be any type of pulley that may engage with the brush belt B1 and may transfer rotational energy between pulleys. In one exemplary embodiment, any pulley of the brush drive system 670 discussed herein may be a V-groove style pulley that engages with a brush belt and transfers rotational energy between pulleys. In another exemplary embodiment, any pulley of the brush drive system 670 discussed herein may be a multiple groove pulley that engages with a brush belt and transfers rotational energy between downstream pulleys. In another exemplary embodiment, any pulley of the brush drive system 670 discussed herein may be a step style pulley that engages with a brush belt and transfers rotational energy between downstream pulleys. In another exemplary embodiment, any pulley of the brush drive system 670 discussed herein may be a cone style pulley that engages with a brush belt and transfers rotational energy between downstream pulleys.

Implement 610 also includes a second or auger drive system 700 that operably engages with the PTO 630 of implement 610. As best seen in FIG. 21A, the auger drive system 700 includes a first drive axle or auger drive axle 702 that operably engages with the second output 638C of gearbox 638. Particularly, the auger drive axle 702 includes a first or input end 702A that is operative with the second output 638C of gearbox 638, a second or output end 702B that is operative with a PTO auger pulley of auger drive system 700, and a longitudinal or rotational axis 702C extending between the input end 702A and the output end 702B. The auger drive axle 702 is also rotatably supported with the housing 620 at the first side 630D by a pillow block bearing 702D.

As best seen in FIG. 23, the auger drive system 700 also includes a PTO auger pulley 704 that operably connects with the auger drive axle 702 at the output end 702B. The auger drive system 700 also includes a jockey pulley 706 that is downstream of the PTO auger pulley 704 and is configured to apply tension along an auger belt B2 of the auger drive system 700 directly after the PTO auger pulley 704. Auger drive system 700 also includes an auger pulley 708 that operably connects with the drive shaft 652 at the first end 652A of the auger 650 (see FIGS. 21 and 23). In the present disclosure, the auger pulley 708 is downstream of the jockey pulley 706 while being configured to transfer rotational energy to the drive shaft 652 (and all components of the auger 650 that rotate with the drive shaft 652) received from the jockey pulley 706.

The auger drive system 700 also includes a tensioner 710 that has a tension pulley 712. In this embodiment, the tension pulley 712 engages with a tension arm of tensioner 710 similar to tensioner 110 of auger drive system 110 of implement 10 in which the tension arm of the tensioner 710 applies a biasing force on the auger belt B2 based on the biasing characteristics of a biaser of the tensioner 710. It should be noted that tensioner 710 and the tension pulley 712 are positioned intermediate PTO auger pulley 704 and the auger pulley 708 (see FIG. 23). With this configuration, tension pulley 712 is configured to apply variable tension along auger belt B2 of the auger drive system 700 as the auger belt B2 circulates between the PTO auger pulley 704, the jockey pulley 706, and the auger pulley 708.

It should be understood that the pulleys 704, 706, 708, 712 of the auger drive system 700 may be any type of pulley that may engage with the auger belt B2 and may transfer rotational energy between pulleys. In one exemplary embodiment, any pulley of the auger drive system 700 discussed herein may be a V-groove style pulley that engages with a brush belt and transfers rotational energy between pulleys. In another exemplary embodiment, any pulley of the auger drive system 700 discussed herein may be multiple groove pulley that engages with a brush belt and transfers rotational energy between pulleys. In another exemplary embodiment, any pulley of the auger drive system 700 discussed herein may be a step style pulley that engages with a brush belt and transfers rotational energy between downstream pulleys. In another exemplary embodiment, any pulley of the auger drive system 700 discussed herein may be a cone style pulley that engages with a brush belt and transfers rotational energy between downstream pulleys.

Similar to the brush drive system 70 and the auger drive system 100 of implement 10, the brush drive system 670 and the auger drive system 700 may rotate and/or spin the brush 640 and the auger 650, particularly the drive shaft 652 and sets of blades 656, at a desired rate or speed (e.g., revolutions per minute (RPM)). In one instance, the brush drive system 670 is configured to rotate the brush 640 at a first speed of rotation or a first rotational speed, and the auger drive system 700 is configured to rotate the drive shaft 652 and sets of blades 656 at a second speed of rotation or second rotational speed; the first speed of rotation and the second speed of rotation may be different from one another. More particularly, the brush drive system 670 is configured to rotate the brush 640 at the first speed of rotation, and the auger drive system 700 is configured to rotate the drive shaft 652 and sets of blades 656 at the second speed of rotation that is greater than the first speed of rotation. Specifically, the second speed of rotation generated by the auger drive system 700 is three time greater than the first speed of rotation generated by the brush drive system 670 (i.e., a speed rotation of 3:1). Specifically, the first speed of rotation of the brush 640 is variable and is limited to about 1600 RPMs by the brush drive system 670. The second speed of rotation of the auger 650 is also variable and is limited to about 4800 RPMs by the auger drive system 700.

Furthermore, the brush drive system 670 and the auger drive system 700 are also configured to allow the brush 640 and the auger 650 to spin and/or rotate so that the velocities of the lateral surfaces of the brush 640 and the auger 650 are substantially matched with one another. It should be noted that the terms “matched” or “substantially matched” with respect to the velocities of the lateral surfaces of the brush 640 and the auger 650 may relate to ranges of matches velocities or velocity approximations. In one example, the lateral surface velocity of the brush 640 is preferably within or approximately within five percent of the lateral surface velocity of the auger 650. In another example, the lateral surface velocity of the brush 640 is within a range of about five percent but no more than five percent of the lateral surface velocity of the auger 650.

In the present disclosure, the brush drive system 670 and the auger drive system 700 are both belt-driven system. In other exemplary embodiments, the brush drive system 670 and the auger drive system 700 mentioned herein may be operated by other drive means for rotating the brush 640 and the auger 650. In one exemplary embodiment, a brush drive system and an auger drive system mentioned herein may be chain-drive system for rotating a corresponding brush and a corresponding auger assembly. In one exemplary embodiment, a brush drive system and an auger drive system mentioned herein may be gear-drive system for rotating a corresponding brush and a corresponding auger assembly. In one exemplary embodiment, a brush drive system and an auger drive system mentioned herein may be cable-drive system for rotating a corresponding brush and a corresponding auger assembly.

Implement 610 may also include a first shroud or guard 720 and a second shroud or guard 722 (see FIG. 21). In the present disclosure, the first shroud 720 operably engages with the housing 620, particularly with the first side wall 620D of the housing 620, for protecting the auger drive system 700. For reference, the first shroud 720 protects and shields the auger drive system 700 shown in FIG. 21 (illustrated in phantom lines) when the first shroud 720 is engaged with the housing 620. Similarly, the second shroud 722 operably engages with the housing 620, particularly with the second side wall 620E of the housing 620, for protecting components of the brush drive system 670. For reference, the second shroud 722 protects and shields components of the brush drive system 670 shown in FIG. 21 (illustrated in phantom lines) when the second shroud 722 is engaged with the housing 620.

Having now discussed the systems, assemblies, and components of implement 610, a method of operating the implement 610 to remove unwanted vegetation is now discussed in greater detail below. For brevity, it should be understood that steps of engaging the implement 10 to the vehicle 1 as previously discussed apply equally to engaging the implement 610 to the vehicle 1. For brevity, it should also be understood that such steps of preconfiguring and/or setting the implement 10 to a desired cut height prior to performing any cutting operation as previously discussed apply equally to the preconfiguring and/or setting the implement 610 to a desired cut height.

Prior to operating the implement 610 for damaging and/or destroying weeds and other unwanted vegetation from a ground surface, the operator may initiate the PTO 6 of the vehicle 1 to rotate both the brush 640 and the auger 650. In operation, the PTO 6 of the vehicle 1 applies rotational energy on the PTO 630 of the implement 610 by the first PTO belt 632. Based on this configuration, the belt 632 then transfers the rotational energy along the components of the PTO 630, including the first PTO pulley 631, the first PTO drive shaft 633, the second PTO pulley 634, the third PTO pulleys 635, the second PTO belt 636, the second PTO drive shaft 637, and the gearbox 638. Once the rotational energy reaches the gearbox 638 at the input 638a, the gearbox 638 transfers the rotational energy to each of the brush drive system 670 and the auger drive system 700 to rotate the brush 640 and the auger 650 at different speeds of rotation. Based on the structural configuration of the gearbox 638 in this embodiment, the gearbox 638 applies independent rotational forces simultaneously on the brush and auger drive axles 672, 702 of the brush drive system 670 and the auger drive system 700.

With respect to the brush drive system 670, the brush drive axle 672 transfers the rotational energy to the PTO brush pulley 674 based on the engagement between the brush drive axle 672 and the PTO brush pulley 674. The PTO brush pulley 674 then transfers the rotational energy to downstream components of the brush drive 66 system 670 via the brush belt B1. Particularly, the rotational energy is transferred from the PTO brush pulley 674 to the downstream pulleys in the following order: brush pulley 676 and tension pulley 680 of tensioner 678. It should be noted that the tension of the brush belt B1 may also be adjusted based on the tension and/or biasing force applied by the tensioner 678. Upon such application of rotational force to the brush drive system 670, the brush 640 rotates in a first rotational direction or clockwise direction (similar to the rotational direction of brush 640 shown in FIG. 15A).

With respect to the auger drive system 700, the auger drive axle 702 transfers the rotational energy to the PTO auger pulley 704 based on the engagement between the auger drive axle 702 and the PTO auger pulley 704. The PTO brush pulley 704 then transfers the rotational energy to downstream components of the auger drive system 700 via the auger belt B2. Particularly, the rotational energy is transferred from the PTO auger pulley 704 to the downstream pulleys in the following order: jockey pulley 706, auger pulley 708, and lastly the tension pulley 712 of tensioner 710. It should be noted that the tension of the auger belt B2 may also be adjusted based on the tension and/or biasing force applied by the tensioner 710. Upon such application of rotational force to the auger drive system 700, the auger 650 (particularly the drive shaft 652 and the sets of blades 656) rotates in a second rotational direction or counterclockwise direction that is opposite to the first rotational direction of the brush 640 (similar to the rotational direction of auger 650 shown in FIG. 15A).

It should be noted that the gearbox 638 transfers the rotational energy to the brush drive system 670 and the auger drive system 700 concurrently or simultaneously based on the structural connections between the gearbox 638, the brush drive axle 672 of brush drive system 670, and the auger drive axle 702 of auger drive system 700.

Once the brush drive system 670 and the auger drive system 700 are transferred the rotational energy from the PTO 630, the brush 640 and the auger 650 begin to rotate simultaneously. As the implement 610 traverses a ground surface (similar to implement 10 shown in FIGS. 15A-15D), one or more blades of the sets of blades 656 may capture and lift one or more weeds of an unwanted vegetation (similar to blades 56 shown in FIGS. 15A-15D) from a turf or lawn area as the sets of blades 656 rotate with the drive shaft 652 with at least one tooth of a plurality of teeth 656G. At this stage, it should be understood that the brush 640 may contact the unwanted vegetation but is free from destroying or separating blades of grass from the ground surface that make up the lawn or turf area with the set of bristles 640F in same manner as mentioned herein with respect to unwanted vegetation.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An implement for attachment with a vehicle, the implement comprising:
a frame;
a housing operably engaged with the frame;
a brush rotatably engaged with the housing; and
an auger rotatably engaged with the housing, the auger comprises:
an auger drive shaft; and
a plurality of blades removably engaged with the auger drive shaft.

2. The implement of claim 1, further comprising:
a drive system operably engaged with the brush and the auger and configured to simultaneously rotate the brush and the auger.

3. The implement of claim 2, wherein the drive system is configured to substantially match velocities of lateral surfaces of the auger and the brush.

4. The implement of claim 2, wherein the drive system comprises:
a power take-off (PTO) system adapted to be operable with the vehicle;
a brush drive system rotatably engaged with the PTO system; and
an auger drive system rotatably engaged with the PTO system and is separate from the brush drive system, wherein the auger drive shaft is a part of the auger drive system.

5. The implement of claim 4, wherein the drive system further comprises:
a gearbox of the PTO system;
an auger drive axle of the auger belt system that rotatably engages with the gearbox at a first output; and
a brush drive axle of the auger belt system that rotatably engages with the gearbox at a second output opposite to the first output.

6. The implement of claim 4, further comprising:
a first side of the housing supporting the auger drive system; and
a second side of the housing opposite to the housing supporting the brush drive system; and
a cavity defined between the first side and the second side housing the brush and the auger.

7. The implement of claim 1, further comprising:
a first drive axis defined along the brush; and
a second drive axis defined along the auger;
wherein the second drive axis of the auger is positioned behind the first drive axis of the brush.

8. The implement of claim 1, wherein the auger further comprises:
a first set of blades of the plurality of blades;
a second set of blades of the plurality of blades; and
a third set of blades of the plurality of blades;
wherein the first set of blades, the second set of blades, and the third set of blades are offset from one another and are configured to capture one or more types of vegetation provided on a ground surface.

9. The implement of claim 8, wherein the auger further comprises:
a first radius defined by each blade of the first set of blades;
a second radius defined by each blade of the second set of blades that is greater than the first radius; and
a third radius defined by each blade of the third set of blades that is greater than the first radius and the second radius.

10. The implement of claim 9, wherein the first set of blades, the second set of blades, and the third set of blades are arranged in a stairstep configuration.

11. The implement of claim 1, wherein the auger further comprises:
a set of spacers operably engaged with the auger drive shaft and the plurality of blades;
wherein each spacer of the set of spacers separates two adjacent blades of the plurality of blades along the auger drive shaft.

12. The implement of claim 11, where each spacer of the set of spacers in integrally formed with a respective blade of the plurality of blades.

13. The implement of claim 1, wherein the auger further comprises:
a keyway defined between a first end of the drive shaft and a second end of the drive shaft; and
a keyed portion provided with each blade of the plurality of blades that is operable to be received by the keyway of the drive shaft.

14. The implement of claim 13, wherein the keyway is D-shaped along an outer surface of the drive shaft defined between the first end of the drive shaft and the second end of the drive shaft; and
wherein the keyed portion provided with each blade of the plurality of blades is D-shaped and is operable to receive the D-shaped keyway of the drive shaft.

15. A method of damaging unwanted vegetation rooted in a lawn area, the method comprising:
engaging a plurality of blades of an auger of an implement with an auger drive shaft of the auger;
engaging the implement with a vehicle;
rotating the auger and a brush of the implement simultaneously;
capturing the unwanted vegetation at a first height by at least one tooth of a set of teeth of a blade of the plurality of blades;
lifting the unwanted vegetation, by the blade of the plurality blades, into the brush; and
damaging the unwanted vegetation rooted in the lawn area.

16. The method of claim 15, wherein the step of engaging the plurality of blades with the auger drive shaft further includes that each blade of the plurality of blades is removably engaged with the auger drive shaft.

17. The method of claim 15, wherein the step of rotating the auger and the brush of the implement simultaneously further comprising:
rotating the brush about a first drive axis; and
rotating the auger about a second drive axis;
wherein the second drive axis is positioned behind the first drive axis.

18. The method of claim 15, further comprising capturing the unwanted vegetation at a second height by at least one tooth of a second set of teeth of a second blade of the plurality of blades, wherein the second height is greater than the first height; and
lifting the unwanted vegetation, by the second blade of the plurality blades, into the brush.

19. The method of claim 18, further comprising:
capturing the unwanted vegetation at a third height by at least one tooth of a third set of teeth of a third blade of the plurality of blades, wherein the third height is greater than the first height and the second height; and
lifting the unwanted vegetation, by the third blade of the plurality blades, into the brush.

20. The method of claim 15, wherein the step of engaging the plurality of blades with the drive shaft further comprises:
engaging a keyed portion of each blade of the plurality of blades with a keyway defined inside of the drive shaft.
